(19) United States
(12) Patent Application Publication
(10) Pub. No.: US 2019/0362602 A1
(43) Pub. Date: Nov. 28, 2019

(54) BE THE HOUSE GAMING SYSTEM

(71) Applicant: Brian C. Watt, (US)

(72) Inventor: Brian C. Watt, Germantown, MD (US)

(73) Assignee: Brian C. Watt, Germantown, MD (US)

(21) Appl. No.: 15/989,758

(22) Filed: May 25, 2018

(51) Int. Cl. G07F 17/32; A63F 13/335

(52) U.S. Cl. CPC G07F 17/3293; G07F 17/3251; A63F 13/335; G07F 17/323

(57) ABSTRACT

A wager based gaming system administered and controlled by a hosting operator licensed by a gaming regulatory body provides a player with the ability to apply for becoming a house type participant that is allowed to assume a house position for a substantial amount of time and number of consecutive wager based games against other players. This can include accepting input from the player regarding applying to become a house type participant, facilitating the qualification of the player as eligible, and administering multiple wager based games on with the qualified player acting as a house type participant and other players acting as player type participants. Player qualification can include determining the ability of the player to assume a sufficient amount of risk. The system can also extend a limited gaming license from the gaming regulatory body through the hosting operator to the qualified player, and can also facilitate promotional activities regarding the qualified player.

### TECHNICAL FIELD

The present invention relates generally to wager-based gaming, and more particularly to wager-based gaming systems playable over a network.

### BACKGROUND

Traditional gaming systems permit players to gamble from player positions in limited ways. Brick and mortar casinos, card houses, cruise ships, and other gaming establishments allow players to occupy player positions where any gaming by players against the establishment or “house” is done under rules or systems that provide superior odds to the gaming establishment or operator. Many gaming operators are licensed and regulated, and take advantage of the superior odds and probability advantages as part of their compensation for providing games and facilitating wagering opportunities for players. Of course, such gaming operators and establishments also take on the risk of losses in the event that players win against them during such games.

Most players inevitably lose to the house, however, and many players have at one time or another wished for some opportunity to play under the kinds of house-friendly rules and superior odds that favor the typical gaming operator. Such players may be more willing to spend more resources and facilitate further gaming activities in situations where these advantages might be leveraged for them as well.

Although traditional gaming systems and methods have worked well in the past, improvements are still desirable. In particular, what is desired are gaming systems and methods that allow players to benefit from traditional house-only odds and advantages.

### SUMMARY

It is an advantage of the present disclosure to provide new gaming systems and methods that allow players to benefit from traditional house-only odds and advantages. This can be accomplished at least in part through the use of gaming systems that are hosted by a gaming entity over a network, wherein the gaming entity permits players to assume the “dealer” or other house positions for the purpose of playing house-based games against other players. In particular, such “Be The House” gaming systems and methods can include ways for the qualifying or “vetting” of applying players to determine the ability of such players to assume the risks of potentially large losses, as well as ways to extend gaming license provisions from a governing body through the operator and to the players.

Embodiments of the present disclosure include a wager based gaming system having an interface configured for communications with at least one other device in the gaming system, a memory, and a controller coupled to the interface and the memory. The controller can be configured to execute a plurality of instructions stored in the memory for a variety of process steps. Pertinent process steps can include providing a player with the ability to apply for becoming a house type participant in the gaming system, accepting input from the player regarding the player applying to become a house type participant in the gaming system, facilitating the qualification of the player as eligible to become a house type participant in the gaming system, and administering multiple wager based games on the gaming system with the qualified player acting as a house type participant and other players acting as player type participants. The gaming system can be administered and controlled by a hosting operator licensed by a gaming regulatory body. Also, the house type participant can be allowed to assume a house position for a substantial amount of time and a substantial number of consecutive wager based games against other players in the gaming system. Qualifying the player can include determining the ability of the player to assume a sufficient amount of risk with respect to being a house type participant.

In various detailed embodiments, further process steps can include extending a limited gaming license from the gaming regulatory body through the hosting operator to the qualified player, facilitating promotional activities regarding the qualified player to other players acting as player type participants, or both. The limited gaming license can permit the qualified player to become a house type participant in at least one wager based game, but does not permit the qualified player to conduct all gaming activities that the hosting operator is licensed to conduct via its license from the gaming regulatory body. The promotional activities can include advertising on behalf of the qualified player, providing specialized house type participant player points to the qualified player, providing player points at a specialized rate to other players acting as player type participants who play the multiple wager based games with the qualified player acting as the house type participant, or any combination thereof.

The multiple wager based games can include blackjack, roulette, craps, pai gow poker, pai gow tiles, Three Card Poker, Let It Ride, Caribbean Stud, Fortune Wheel, Casino War, slots, video poker, and any other suitable house type game, as well as any combination thereof. In some arrangements, the multiple wager based games can be provided over the Internet. In some arrangements, the multiple wager based games can be played with the qualified player acting as a house type participant being located in a first gaming jurisdiction and at least one other player acting as player type participant being located in a second gaming jurisdiction separate from the first gaming jurisdiction.

In various detailed embodiments, determining the ability of the player to assume a sufficient amount of risk with respect to being a house type participant can include requiring a minimum monetary deposit into a secure holding account. Also, facilitating the qualification of the player as eligible to become a house type participant can include requiring the player to act as house type participant for a minimum number of wager based games, a minimum amount of time, or both.

In further embodiments of the present disclosure, a computer readable medium can include at least computer program code for presenting a wager based game using a computing apparatus. The computer readable medium can include computer program code for providing to a user via a computing apparatus the ability to apply for becoming a house type participant in a gaming system that is administered and controlled by a hosting operator licensed by a gaming regulatory body. Also included can be computer program code for accepting input from the player regarding the player applying to become a house type participant in the gaming system, for facilitating the qualification of the player as eligible to become a house type participant in the gaming system, and for facilitating the administration of multiple wager based games on the gaming system with the qualified player acting as a house type participant and other players acting as player type participants.

In various detailed embodiments, additional computer program code can be for facilitating the extension of a limited gaming license from the gaming regulatory body through the hosting operator to the qualified player, where the limited gaming license permits the qualified player to become a house type participant in at least one wager based game, but does not permit the qualified player to conduct all gaming activities that the hosting operator is licensed to conduct via its license from the gaming regulatory body. Further computer program code can be for facilitating promotional activities regarding the qualified player to other players acting as player type participants. Further details regarding the computer program code can correlate to those for the system above, alone or in any desired combination.

In still further embodiments of the present disclosure, various methods of facilitating a wager based game using a computing apparatus are provided. The methods can include the steps of providing a player with the ability to apply for becoming a house type participant in the gaming system, accepting input from the player regarding the player applying to become a house type participant in the gaming system, facilitating the qualification of the player as eligible to become a house type participant, and administering multiple wager based games on the gaming system with the qualified player acting as a house type participant and other players acting as player type participants, among other possible method steps.

In various detailed embodiments, further method steps can include extending a limited gaming license from the gaming regulatory body through the hosting operator to the qualified player, facilitating promotional activities regarding the qualified player to other players acting as player type participants, or both. Further details regarding the various methods provided can correlate to those for the system above, alone or in any desired combination.

Other apparatuses, systems, methods, features and advantages of the disclosure will be or will become apparent to one with skill in the art upon examination of the following figures and detailed description. It is intended that all additional apparatuses, systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed inventive apparatuses, systems and methods for allowing players to act as the house for house-based wagering games. These drawings in no way limit any changes in form and detail that may be made to the disclosure by one skilled in the art without departing from the spirit and scope of the disclosure.

FIG. 1A illustrates in front perspective view an exemplary computing device according to one embodiment of the present disclosure.

FIG. 1B illustrates in front perspective view an alternative exemplary computing device according to one embodiment of the present disclosure.

FIG. 1C illustrates in block diagram format an exemplary computerized data network according to one embodiment of the present disclosure.

FIG. 2 illustrates a diagram of an exemplary client or end user computing device or system according to one embodiment of the present disclosure.

FIG. 3 illustrates in block diagram format an exemplary client system for a mobile device according to one embodiment of the present disclosure.

FIG. 4 illustrates in block diagram format an exemplary server system according to one embodiment of the present disclosure.

FIG. 5 illustrates in block diagram format an exemplary application server system according to one embodiment of the present disclosure.

FIG. 6 illustrates a flowchart of an exemplary basic method of allowing a player to assume a house position according to one embodiment of the present disclosure.

FIG. 7A illustrates a screen shot of an exemplary Player Application Page for a player applying to become a house type participant according to one embodiment of the present disclosure.

FIG. 7B illustrates a screen shot of an exemplary Player Financial Page for a player applying to become a house type participant according to one embodiment of the present disclosure.

FIG. 8 illustrates a flowchart of an exemplary method of qualifying a player to become a house type participant according to one embodiment of the present disclosure.

FIG. 9A illustrates a screen shot of an exemplary initial Player Setup Page for a qualified player that is initially setting up their presence as a house type participant according to one embodiment of the present disclosure.

FIG. 9B illustrates a screen shot of an exemplary Player Settings Page for a qualified and established house type participant to change the settings on his or her established presence according to one embodiment of the present disclosure.

FIG. 10 illustrates a flowchart of an exemplary method of a qualified player setting up a gaming table or section within the host operator establishment according to one embodiment of the present disclosure.

FIG. 11 illustrates a screen shot of an exemplary virtual casino floor having a section for a qualified and established house type participant according to one embodiment of the present disclosure.

FIG. 12 illustrates a screen shot of an exemplary virtual gaming table for a qualified and established house type participant from the perspective of another player acting as a player type participant according to one embodiment of the present disclosure.

FIG. 13 illustrates a screen shot of the exemplary virtual gaming table of FIG. 12 from the perspective of the established house type participant according to one embodiment of the present disclosure.

FIG. 14 illustrates a screen shot of an exemplary data page for an active gaming table from the perspective of an established house type participant according to one embodiment of the present disclosure.

FIG. 15 illustrates a flowchart of an exemplary method of facilitating the play of a wager based game with a player assuming a house position on a computing apparatus according to one embodiment of the present disclosure.

### DETAILED DESCRIPTION

Exemplary applications of apparatuses and methods according to the present disclosure are described in this section. These examples are being provided solely to add context and aid in the understanding of the disclosure. It will thus be apparent to one skilled in the art that the present disclosure may be practiced without some or all of these specific details. In other instances, well known process steps have not been described in detail in order to avoid unnecessarily obscuring the present disclosure. Other applications are possible, such that the following examples should not be taken as limiting.

In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to devices, systems and methods for providing, conducting and facilitating the play of “Be The House” gaming activities on new gaming systems that allow players to assume a house position for the purpose of playing house-based games against other players, such that players are able to benefit from traditional house-only odds and advantages. Such gaming systems and methods can include ways for the qualifying of applying players to determine the ability of such players to assume the risks of potentially large losses, as well as ways to extend gaming license provisions from a governing body through the operator and to the players.

In some casinos and gaming establishments, such as in California card houses, for example, players are allowed to bank temporarily a “dealer” position for purposes of playing wagering games against other players. This can occur for pai gow poker and pai gow tile games, for example, among other possible games. In such arrangements, the banking player decides how much that they are willing to risk or “bank” against all other active players at the table, typically only for a hand or two. This player “bank” position typically rotates around the table, giving every active player at the table an opportunity to bank games against the other active players. The gaming establishment typically conducts the games, such as by dealing cards or tiles, determining wins and losses, and then arranging payouts to and from the banking player accordingly.

Unfortunately, these known methods of allowing players to take a banking position against other players are limited in many ways. For one thing, the types of games that can be banked by regular players are typically limited to only a few types of wagering games. For another, the amount of hands or plays that a player is able to act as bank are typically limited to only one or two plays before that position then rotates around the table. For another, the ability to bank game play is rotated between all players at the table rather than staying with a single player. For yet another, the administration of rotating banking abilities from player to player often hinders and confuses the flow of actual game play.

As disclosed here, the Be The House Gaming System allows for traditional players to participate in the wagering experience of traditional casino style games in a way that is highly desirable and that is not currently offered by any brick and mortar or virtual gaming operator. Unlike any other gaming offerings, the Be The House Gaming System allows traditional players to assume a dealer or house position in any of a wide variety of games for an extended number of plays and time, and without creating any of the logistical complications arising from rotating a player bank position. Games can include traditional table game offerings, such as blackjack, roulette, craps, and the like, as well as many other wagering games. Such provisions can be made through the resources of an established gaming operator without requiring a traditional player to take on the prohibitive monetary and temporal costs of starting up their own casino or other gaming operation and continuing operations with resource intensive ongoing overhead and maintenance.

In addition to the foregoing opportunities and features that traditional players may find attractive, the Be The House Gaming System also provides benefits to a gaming operator providing and hosting the system. A hosting entity such as a casino, for example, can attract new customers and retain existing ones by providing better offerings that allow customers to bank games as if they are the house. The hosting gaming operator can also eliminate their own risk of big losses in the event of players having big wins or winning streaks. Furthermore, the hosting gaming operator can take a small fee or percentage based on the gaming actions when allowing players to assume a house position. This advantage can be significant in instances of high volume, particularly where the system is virtually based. Still further, the hosting gaming operator can benefit from increased advertising and promotional abilities by way of hosting such a gaming system.

Additional advantageous features of a Be The House Gaming System can include allowing players assuming a dealer position to remain anonymous, such as where players assuming a dealer position may wish to have their identities unknown to other players, particularly in the case of virtual casinos and systems. Alternatively, or in addition, a player assuming a dealer position may be provided with various advertising opportunities. The players assuming a dealer position (or “banking players”) may advertise themselves or on behalf of sponsors or other entities. For example, a player assuming a dealer position in a virtual casino may run a long standing popular enterprise where one or more advertisers may be employed to take advantage of that popularity. In addition, players assuming a dealer position may be incentivized to invite family, friends, or other persons to play at “their virtual casinos, further increasing interest and overall play and participation. These various features may attract many players who might otherwise not play as much or at all.

The Be The House Gaming System can facilitate a casino or other hosting operator to allow a traditional player to bank traditional wagering games for a set time period, set number of hands or plays, or indefinitely, while still administering and controlling the games, and also profiting from the play of games. In various arrangements, a player desiring to assume a house position can be qualified or “vetted,” can have a limited gaming license extended to them through the hosting operator, and/or can be required to put a certain minimum deposit into an escrow fund or otherwise guarantee the ability to pay out in the event of big losses. This minimum deposit amount can be based on a certain minimum number of game plays, the betting limit for those games, and the types of games being played, among other factors. For example, higher multiples of the betting limit may be required for games such as craps and roulette.

In various arrangements, a player assuming a house position (e.g. “banking player”) may be required to bank or be the house for a minimum number of hands or plays, a minimum amount of time, or both. The casino or other hosting operator can control the dealing of cards, throwing of dice, or actions of other gaming items, determine winning outcomes, and administer payouts to the proper players accordingly, thus ensuring a higher level of integrity for all games and players.

The Be The House Gaming System can be applied for any traditional house versus player type of wagering game, such as, for example, blackjack, roulette, craps, pai gow poker, pai gow tiles, Three Card Poker, Let It Ride, Caribbean Stud, Fortune Wheel, Casino War, slots, video poker, and the like. In various arrangements, the hosting operator can take a small percentage, vigorish (“vig”), or flat fee for each win or hand, or any combination thereof, as the compensation of the hosting operator for providing the hosting opportunity and managing the operations of the games.

In various arrangements, the hosting operator may provide the banking players with profit and loss statements, player rewards points, the ability to bank anonymously, advertising abilities, and other desirable features. In some cases, banking players may be provided with specialized banking rewards points, which can be used to unlock desirable features with respect to advertising or other bonuses that are not available to all banking type players. Such added features or bonuses can include customizations or additions with respect to advertising, such as where a significant banking player may desire to customize their own online casino. These features or bonuses can include variations on the amount and types of games that the player can assume the house position, the number of tables that the player can utilize, the number of player positions at a table, reductions in the vig or flat fee charged to the player, and added customizations or added features to advertising and/or the appearance or “skin” on the tables or areas where the player is allowed to assume the house position. These can include, for example, the felt on the tables, chip designs, dealer uniforms, scenery backgrounds, banner ads, and the like. Such customizations can allow a player to create their own mini casino, either virtually or in a particular area of a physical casino or other gaming establishment.

The Be The House Gaming System can be usable for wagers placed in the form of fiat money, representative chips, tokens or credits, virtual currency, or any crypto currency in any current or future form. In various arrangements, banking players could be rewarded by a reduction in casino operator fees based on the aggregate amount wagered or risked from the house position that they have funded over a set duration of time or number of game plays, such as, for example, a day, week, month, 90 days, or 100 plays, 1000 plays, 100,000 plays, and so forth. Furthermore, a qualified applicant that becomes a house type participant can be an individual, a group of individuals, a corporate entity, or any other party that may suitably act as a house type participant. While the disclosed systems and methods often refer to players or individuals as an applicant or qualified house type participant, it will be understood that an applicant or house type participant can refer to any type of suitable party.

The disclosed gaming systems and methods may be provided as physical items at a brick and mortar gaming establishment, as well as on one or more computing devices. As such, this disclosure may be applied to any form of presenting gaming activities, whether in person, virtually on a computing device, or otherwise. Although the various examples set forth herein are focused on computerized versions of the disclosed gaming activities, it will be readily understood that such gaming activities can be played in a number of different ways and modes, such as with physical cards, tiles, pieces or items, or virtual representations of these items, such that the disclosure is not limited only to computerized embodiments.

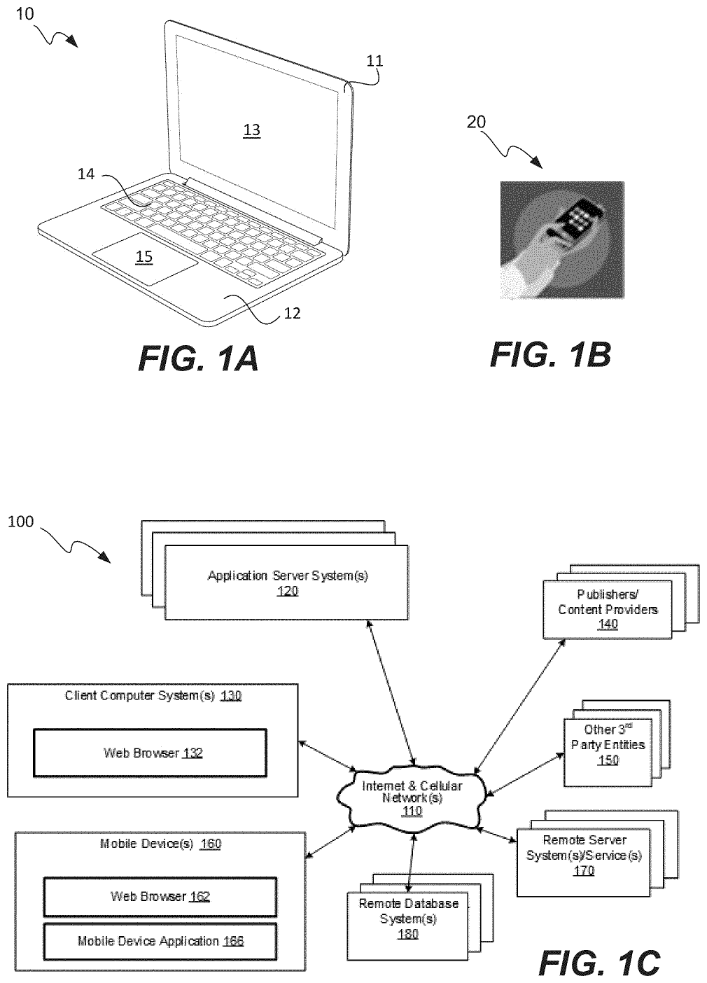

Referring first to FIG. 1A, an exemplary computing device according to one embodiment of the present disclosure is illustrated in front perspective view. Computing device 10, which can be a laptop computer, can be particularly adapted to provide various wager based gaming activities to a user, such as blackjack, roulette, craps, pai gow poker, and other such games, as provided herein. It will be readily appreciated that computing device 10 can be provided in numerous other configurations and formats while still being able to provide the disclosed gaming activities, such that the provided laptop example is for illustrative purposes only. For example, computing device 10 could also be a desktop computer, tablet computer, smart phone, personal digital assistant, or the like.

In general, computing device 10 can include an upper portion 11 and a lower portion 12. Upper portion 11 can include a display component 13 having a display region thereupon, while lower portion 12 can include various input devices, such as a keyboard 14 and touchpad 15. Lower portion 12 may also include a processor (not shown) therewithin, which can be adapted to generate or process data for a wager based game, provide display output regarding the wager based game, and accept user input regarding the wager based game. Such a processor can be coupled to the display component 13 and the input devices 14, 15, as well as other components of the computing device. Such other computing device components or items not shown may also be included, as will be readily appreciated, with such items including, for example, speakers, memories, busses, input ports, disk drives, power supplies, wireless interfaces, and the like.

FIG. 1B illustrates in front perspective view an alternative exemplary computing device according to one embodiment of the present disclosure. Smart phone 20 can similarly be used to provide or facilitate the play of a wager based game or other similar activity. As in the foregoing computing device 10, smart phone 20 can include at least a processor, display component having a display region, and one or more input devices, such as a touchscreen, button(s) and/or a keypad. In various embodiments, a wager based game or the like can be provided as an application or “app” on an app store that can be accessed from smart phone 20. Such an app can be downloaded and then played or used on the phone 20. Such an app can be specialized for one form of wager based game, or can be a universal app configured to provide all wager based games that are available for the provider of a “Be The House” gaming system.

FIG. 1C illustrates in block diagram format an exemplary computerized data network according to one embodiment of the present disclosure. Computerized data network 100 can be used to implement a “Be The House Gaming System” adapted for the play of wager based games that allow players to assume a house position, for example. As described in greater detail herein, different embodiments of Be The House Gaming Systems may be configured, designed, and/or operable to provide various different types of operations, functionalities, and/or features generally relating to wager based games that allow players to assume a house position. Further, as described in greater detail herein, many of the various operations, functionalities, and/or features of the disclosed Be The House Gaming System may enable or provide different types of advantages and/or benefits to different entities interacting with the Be The House Gaming System.

According to different embodiments, at least some Be The House Gaming Systems may be configured, designed, and/or operable to provide a number of different advantages and/or benefits and/or may be operable to initiate, and/or enable various different types of operations, functionalities, and/or features, According to different embodiments, at least a portion of the various types of functions, operations, actions, and/or other features provided by the Be The House Gaming System may be implemented at one or more client systems, at one or more server systems, and/or combinations thereof.

According to different embodiments, the Be The House Gaming System 100 may include a plurality of different types of components, devices, modules, processes, systems and the like, which, for example, may be implemented and/or instantiated via the use of hardware and/or combinations of hardware and software. According to various embodiments, the computerized data network 100 adapted for implementation of a Be The House Gaming System may include a plurality of different types of components, devices, modules, processes, systems, etc., which, for example, may be implemented and/or instantiated via the use of hardware and/or combinations of hardware and software. For example, as illustrated in the example embodiment of FIG. 1C, network 100 may include one or more of the following types of systems, components, devices, processes, etc. (or combinations thereof):
Application Server System(s) 120—In at least one embodiment, the Application Server System(s) may be operable to perform and/or implement various types of functions, operations, actions, and/or other features such as those described or referenced herein.
Publisher/Content Provider System component(s) 140
Client Computer System (s) 130
3^{rd} Party System(s) 150
Internet & Cellular Network(s) 110
Remote Database System(s) 180
Remote Server System(s)/Service(s) 170, which, for example, may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
Mobile Device(s) 160—In at least one embodiment, the Mobile Device(s) may be operable to perform and/or implement various types of functions, operations, actions, and/or other features such as those described or referenced herein.

In some embodiments, a decentralized server system may be used for a Be The House Gaming System. Rather than utilizing a centralized server, various system functions can be performed at multiple servers distributed at different locations across a distributed network. As such, while Application Server System(s) 120 can all be on one machine or placed at a single location, Application Server System(s) 120 may also be on multiple machines at multiple locations. For example, one portion of Application Server System(s) 120 relating to new player applications may be located on a first server within one gaming jurisdiction or other location, while another portion of Application Server System(s) 120 relating to the play and resolution of games may be located on a second server located in another gaming jurisdiction or other location. Communications between the different portions of Application Server System(s) 120 may be arranged as appropriate to facilitate functionality between the different system portions.

In at least one embodiment, a Be The House Gaming System may be operable to utilize and/or generate various different types of data and/or other types of information when performing specific tasks and/or operations. This may include, for example, input data/information and/or output data/information. For example, in at least one embodiment, a Be The House Gaming System may be operable to access, process, and/or otherwise utilize information from one or more different types of sources, such as, for example, one or more local and/or remote memories, devices and/or systems. Additionally, in at least one embodiment, a Be The House Gaming System may be operable to generate one or more different types of output data/information, which, for example, may be stored in memory of one or more local and/or remote devices and/or systems. Examples of different types of input data/information and/or output data/information which may be accessed and/or utilized by a Be The House Gaming System may include, but are not limited to, one or more of those described and/or referenced herein.

According to specific embodiments, multiple instances or threads of a Be The House Gaming System may be concurrently implemented and/or initiated via the use of one or more processors and/or other combinations of hardware and/or hardware and software. For example, in at least some embodiments, various aspects, features, and/or functionalities of the Be The House Gaming System may be performed, implemented and/or initiated by one or more of the various systems, components, systems, devices, procedures, processes, etc., described and/or referenced herein.

In at least one embodiment, a given instance of a Be The House Gaming System may access and/or utilize information from one or more associated databases. In at least one embodiment, at least a portion of the database information may be accessed via communication with one or more local and/or remote memory devices. Examples of different types of data which may be accessed by a Be The House Gaming System may include, but are not limited to, one or more of those described and/or referenced herein.

According to different embodiments, various different types of encryption/decryption techniques may be used to facilitate secure communications between devices in a Be The House Gaming System and/or other networks. Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well-known hardware-based and/or software-based security components, and/or any other known or yet to be devised security and/or hardware and encryption/decryption processes implemented in hardware and/or software.

According to different embodiments, one or more different threads or instances of the Be The House Gaming System may be initiated in response to detection of one or more conditions or events satisfying one or more different types of minimum threshold criteria for triggering initiation of at least one instance of the Be The House Gaming System. Various examples of conditions or events which may trigger initiation and/or implementation of one or more different threads or instances of the Be The House Gaming System may include, but are not limited to, one or more of those described and/or referenced herein.

It will be appreciated that the Be The House Gaming System of FIG. 1C is but one example from a wide range of Be The House Gaming System embodiments which may be implemented. Other embodiments of the Be The House Gaming System (not shown) may include additional, fewer and/or different components/features that those illustrated in the exemplary Be The House Gaming System embodiment of FIG. 1C. Generally, the various techniques for implementing a Be The House gaming system or other similar system described herein may be implemented in software, hardware and/or hardware+software. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Software, hardware and/or software+hardware hybrid embodiments of the Be The House Gaming techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

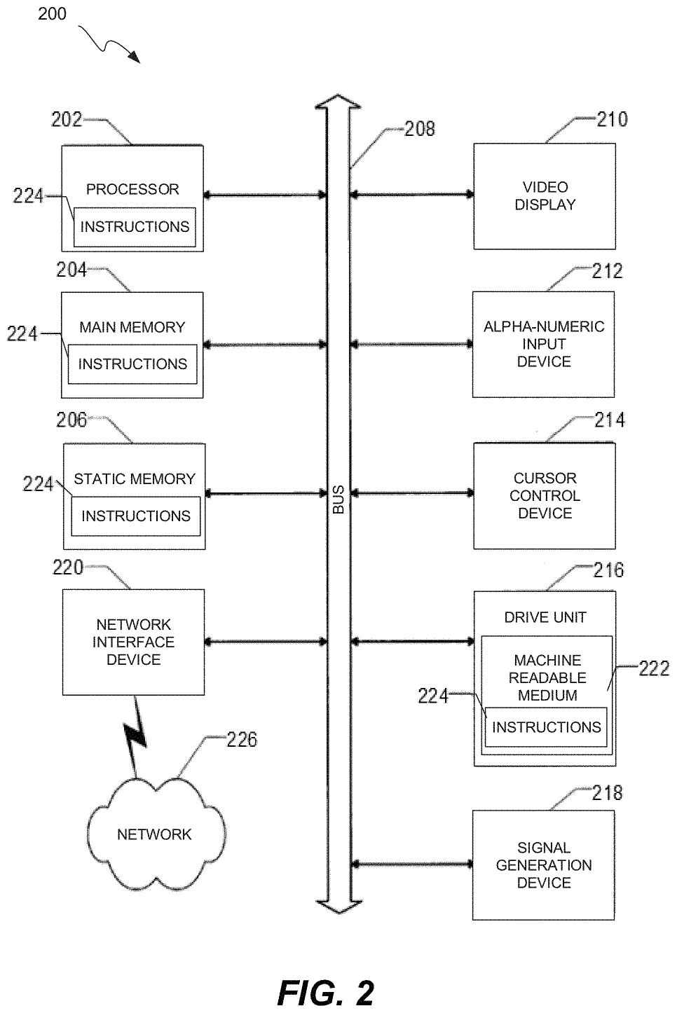

Turning next to FIG. 2, a diagrammatic representation of an exemplary client or end user computing device or system is provided. Computing device or system 200 can be identical or similar to any of the foregoing computer devices 10, 20, as well as any other suitable computing device or system adapted for providing the disclosed Be The House or other wager based gaming systems.

Computing device or system 200 may contain a set of instructions for causing itself or another networked machine to perform any one or more of the methodologies discussed herein. As such, computing device or system 200 may operate as a standalone device or machine, or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Exemplary computer device or system 200 includes a processor 202 (e.g., a central processing unit (CPU), a graphics processing unit (GPU) or both), a main memory 204 and a static memory 206, which communicate with each other via a bus 208. The computer device or system 200 may further include a video display unit 210 (e.g., a liquid crystal display (LCD) or a cathode ray tube (CRT)), and also an alphanumeric input device 212 (e.g., a keyboard), a user interface (UI) navigation device 214 (e.g., a mouse), a disk drive unit 216, a signal generation device 218 (e.g., a speaker) and a network interface device 220. The disk drive unit 216 includes a machine-readable medium 222 on which is stored one or more sets of instructions and data structures (e.g., software 224) embodying or utilized by any one or more of the methodologies or functions described herein. The software 224 may also reside, completely or at least partially, within the main memory 204 and/or within the processor 202 during execution thereof by the computer device or system 200, wherein the main memory 204 and/or the processor 202 may also be constituting machine-readable media.

The software 224 may further be transmitted or received over a network 226 via the network interface device 220 utilizing any one of a number of well-known transfer protocols (e. g., HTTP). While the machine-readable medium 222 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

According to various embodiments, computing device or system 200 may include a variety of components, modules and/or systems for providing various types of functionality. For example, in at least one embodiment, device or system 200 may include a web browser application which is operable to process, execute, and/or support the use of scripts (e.g., JavaScript, AJAX, etc.), Plug-ins, executable code, virtual machines, HTML5 vector-based web animation (e.g., Adobe Flash), etc. In at least one embodiment, the web browser application may be configured or designed to instantiate components and/or objects at the device or system 200 in response to processing scripts, instructions, and/or other information received from a remote server such as a web server. Examples of such components and/or objects may include, but are not limited to, UI components, database components, processing components, and other components that may facilitate and/or enable device or system 200 to perform and/or initiate various types of operations, activities, functions such as those described herein with respect to providing a Be The House Gaming System or other similar wager based gaming system.

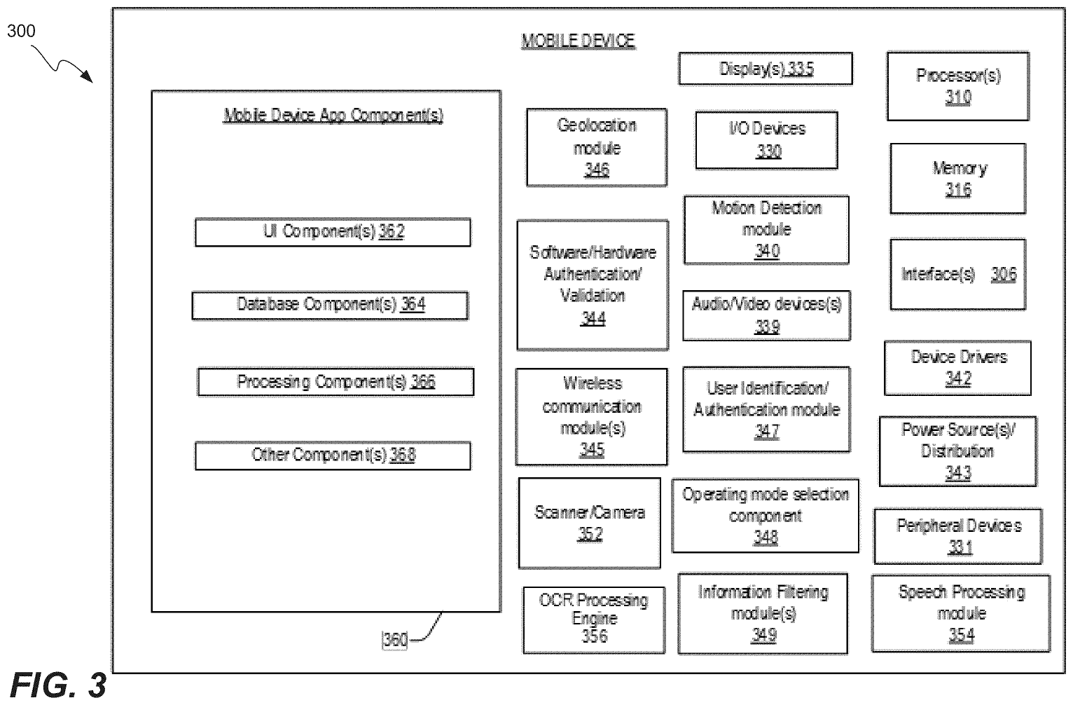

Continuing with FIG. 3, a block diagram of an exemplary client system for a mobile device is provided. In at least one embodiment, the mobile device client system 300 may include a Be The House Mobile Device App Component, which has been configured or designed to provide functionality for enabling or implementing at least a portion of the various Be The House Gaming System software modules or components at the mobile device client system. Such a mobile device app component can be provided for download by a service provider, such as an app store for smart phone devices. Various aspects, features, and/or functionalities of client system 300 may be performed, implemented and/or initiated by one or more of the following types of systems, components, systems, devices, procedures, processes, and the like. Such items can include, for example: Processor(s) 310, Device Drivers 342, Memory 316, Interface(s) 306, Power Source(s)/Distribution 343, Geolocation module 346, Display(s) 335, I/O Devices 330, Audio/Video devices(s) 339, Peripheral Devices 331, Motion Detection module 340, User Identification/Authentication module 347, Client App Component(s) 360, Other Component(s) 368, UI Component(s) 362, Database Component(s) 364, Processing Component(s) 366, Software/Hardware Authentication/Validation 344, Wireless communication module(s) 345, Information Filtering module(s) 349, Operating mode selection component 348, Speech Processing module 354, Scanner/Camera 352, and OCR Processing Engine 356, among other possible components.

As illustrated in the example of FIG. 3, mobile device 300 may include a variety of components, modules and/or systems for providing various functionality. For example, Mobile Device 300 may include Mobile Device Application components (e.g., 360), which, for example, may include, but are not limited to, one or more of the following (or combinations thereof): UI Components 362, Database Components 364, Processing Components 366, and Other Components 368 which, for example, may include components for facilitating and/or enabling the mobile device to perform and/or initiate various types of operations, activities, functions such as those described herein.

In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more different types of data, metadata, and/or other information described and/or referenced herein.

According to different embodiments, Mobile Device 300 may further include, but is not limited to, different types of components, modules and/or systems (or combinations thereof) such as, for example, one or more of the following.
At least one processor 310. In at least one embodiment, the processor(s) 310 may include one or more commonly known CPUs that are deployed in many current consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 316, which, for example, may include volatile memory (e.g., RAM), non-volatile memory (e.g., disk memory, FLASH memory, EPROMs, etc.), unalterable memory, and/or other types of memory. In at least one implementation, the memory 316 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various Be The House gaming components described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the Be The House gaming components described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 306 which, for example, may include wired interfaces and/or wireless interfaces. In at least one implementation, the interface(s) 306 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected electronic game tables, computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Device driver(s) 342. In at least one implementation, the device driver(s) 342 may include functionality similar to at least a portion of functionality implemented by one or more computer system driver devices such as those described herein and/or generally known to one having ordinary skill in the art.
At least one power source (and/or power distribution source) 343. In at least one implementation, the power source may include at least one mobile power source (e.g., battery) for allowing the client system to operate in a wireless and/or mobile environment. For example, in one implementation, the power source 343 may be implemented using a rechargeable, thin-film type battery. Further, in embodiments where it is desirable for the device to be flexible, the power source 343 may be designed to be flexible.
Geolocation module 346 which, for example, may be configured or designed to acquire geolocation information from remote sources and use the acquired geolocation information to determine information relating to a relative and/or absolute position of the client system.
Motion detection component 340 for detecting motion or movement of the client system and/or for detecting motion, movement, gestures and/or other input data from user. In at least one embodiment, the motion detection component 340 may include one or more motion detection sensors such as, for example, MEMS (Micro Electro Mechanical System) accelerometers, that can detect the acceleration and/or other movements of the client system as it is moved by a user.
User Identification/Authentication module 347. In one implementation, the User Identification module may be adapted to determine and/or authenticate the identity of the current user or owner of the client system. For example, in one embodiment, the current user may be required to perform a log in process at the client system in order to access one or more features. Alternatively, the client system may be adapted to automatically determine the identity of the current user based upon one or more external signals such as, for example, an RFID tag or badge worn by the current user that provides a wireless signal to the client system for determining the identity of the current user. In at least one implementation, various security features may be incorporated into the client system to prevent unauthorized users from accessing confidential or sensitive information.
One or more display(s) 335. According to various embodiments, such display(s) may be implemented using, for example, LCD display technology, OLED display technology, and/or other types of conventional display technology. In at least one implementation, display(s) 335 may be adapted to be flexible or bendable. Additionally, in at least one embodiment the information displayed on display(s) 335 may utilize e-ink technology (such as that available from E Ink Corporation, Cambridge, Mass., www.eink.com), or other suitable technology for reducing the power consumption of information displayed on the display(s) 335.
One or more user I/O Device(s) 330 such as, for example, keys, buttons, scroll wheels, cursors, touchscreen sensors, audio command interfaces, magnetic strip reader, optical scanner, etc.
Audio/Video device(s) 339 such as, for example, components for displaying audio/visual media which, for example, may include cameras, speakers, microphones, media presentation components, wireless transmitter/receiver devices for enabling wireless audio and/or visual communication between the client system 300 and remote devices (e.g., radios, telephones, computer systems, etc.). For example, in one implementation, the audio system may include componentry for enabling the client system to function as a cell phone or two-way radio device.
Other types of peripheral devices 331 which may be useful to the users of various client systems, such as, for example: PDA functionality; memory card reader(s); fingerprint reader(s); image projection device(s); social networking peripheral component(s); etc.
Information filtering module(s) 349 which, for example, may be adapted to automatically and dynamically generate, using one or more filter parameters, filtered information to be displayed on one or more displays of the mobile device. In one implementation, such filter parameters may be customizable by the player or user of the device. In some embodiments, information filtering module(s) 349 may also be adapted to display, in real-time, filtered information to the user based upon a variety of criteria such as, for example, geolocation information, contextual activity information, and/or other types of filtering criteria described and/or referenced herein.
Wireless communication module(s) 345. In one implementation, the wireless communication module 345 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Software/Hardware Authentication/validation components 344 which, for example, may be used for authenticating and/or validating local hardware and/or software components, hardware/software components residing at a remote device, game play information, wager information, user information and/or identity, etc.
Operating mode selection component 348 which, for example, may be operable to automatically select an appropriate mode of operation based on various parameters and/or upon detection of specific events or conditions such as, for example: the mobile device's current location; identity of current user; user input; system override (e.g., emergency condition detected); proximity to other devices belonging to same group or association; proximity to specific objects, regions, zones, etc. Additionally, the mobile device may be operable to automatically update or switch its current operating mode to the selected mode of operation. The mobile device may also be adapted to automatically modify accessibility of user-accessible features and/or information in response to the updating of its current mode of operation.
Scanner/Camera Component(s) (e.g., 352) which may be configured or designed for use in scanning identifiers and/or other content from other devices and/or objects such as for example: mobile device displays, computer displays, static displays (e.g., printed on tangible mediums), etc.
OCR Processing Engine (e.g., 356) which, for example, may be operable to perform image processing and optical character recognition of images such as those captured by a mobile device camera, for example.
Speech Processing module (e.g., 354) which, for example, may be operable to perform speech recognition, and may be operable to perform speech-to-text conversion.

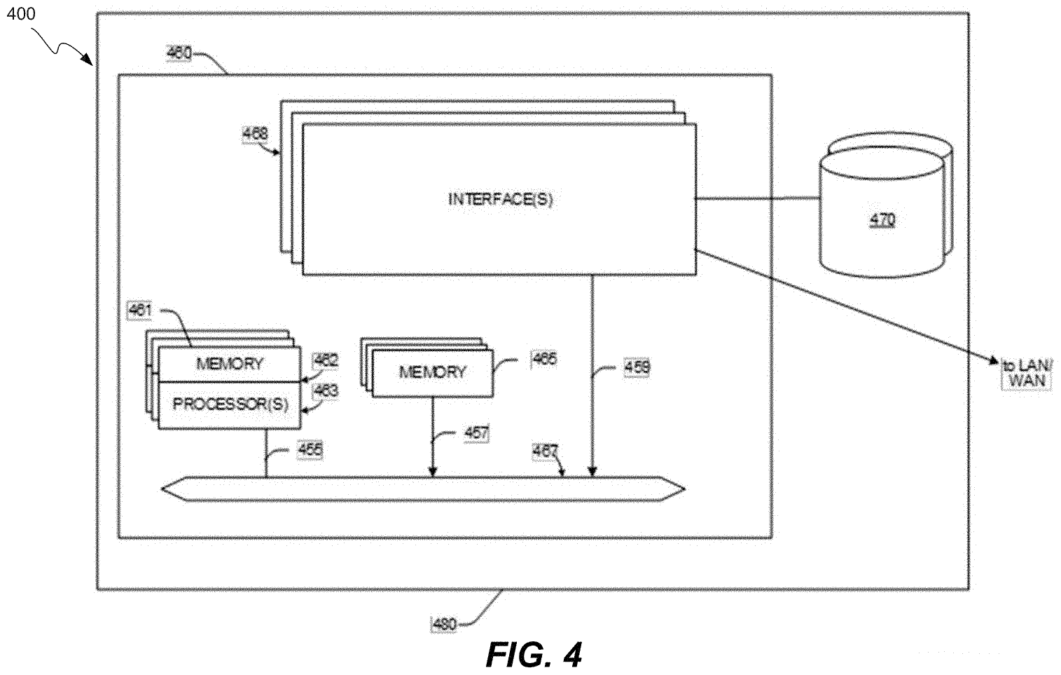

FIG. 4 illustrates in block diagram format an exemplary server system 480, which may be used for implementing various aspects/features described herein. In at least one embodiment, the server system 480 includes at least one network device 460, and at least one storage device 470 (such as, for example, a direct attached storage device). In one embodiment, server system 480 may be suitable for implementing at least some of the Be The House gaming techniques described herein.

According to one embodiment, network device 460 may include a master central processing unit (CPU) 462, interfaces 468, and a bus 467 (e.g., a PCI bus). When acting under the control of appropriate software or firmware, the CPU 462 may be responsible for implementing specific functions associated with the functions of a desired network device. For example, when configured as a server, the CPU 462 may be responsible for analyzing packets; encapsulating packets; forwarding packets to appropriate network devices; instantiating various types of virtual machines, virtual interfaces, virtual storage volumes, virtual appliances; etc. The CPU 462 preferably accomplishes at least a portion of these functions under the control of software including an operating system (e.g. Linux), and any appropriate system software (such as, for example, AppLogic™ software).

CPU 462 may include one or more processors 463 such as, for example, one or more processors from the AMD, Motorola, Intel and/or MIPS families of microprocessors. In an alternative embodiment, processor 463 may be specially designed hardware for controlling the operations of server system 480. In a specific embodiment, a memory 461 (such as non-volatile RAM and/or ROM) also forms part of CPU 462. However, there may be many different ways in which memory could be coupled to the system. Memory block 461 may be used for a variety of purposes such as, for example, caching and/or storing data, programming instructions, etc.

The interfaces 468 may be typically provided as interface cards (sometimes referred to as “line cards”). Alternatively, one or more of the interfaces 468 may be provided as on-board interface controllers built into the system motherboard. Generally, they control the sending and receiving of data packets over the network and sometimes support other peripherals used with the server system 480. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 462 to efficiently perform routing computations, network diagnostics, security functions, etc.

In at least one embodiment, some interfaces may be configured or designed to allow the server system 480 to communicate with other network devices associated with various local area network (LANs) and/or wide area networks (WANs). Other interfaces may be configured or designed to allow network device 460 to communicate with one or more direct attached storage device(s) 470.

Although the system shown in FIG. 4 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device configuration, a network may employ one or more memories or memory modules (such as, for example, memory block 465, which, for example, may include random access memory (RAM)) configured to store data, program instructions for the general-purpose network operations and/or other information relating to the functionality of the various Be The House gaming techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

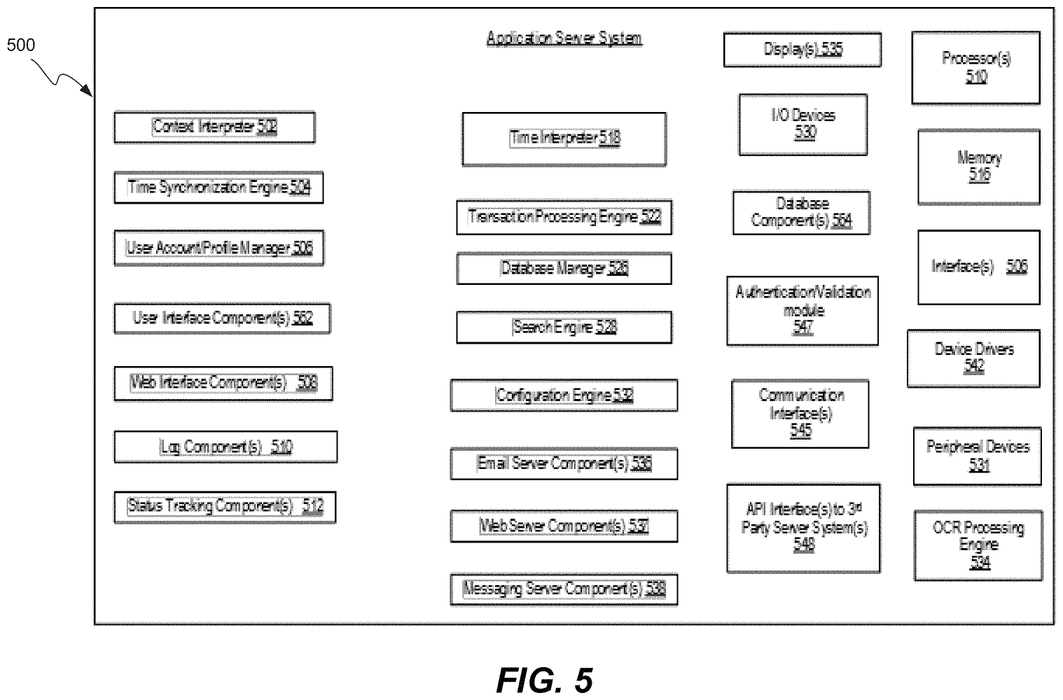

FIG. 5 provides a block diagram of an application server system. Application server system 500 may be operable to perform and/or implement various types of functions, operations, actions, and/or other features associated with providing a Be The House game or application. In at least one embodiment, application server system 500 may include a plurality of components operable to perform and/or implement various types of functions, operations, actions, and/or other features such as, for example:
Context Interpreter (e.g., 502) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof):
   location-based criteria (e.g., geolocation of client device, geolocation of agent device, etc.)
   time-based criteria
   identity of user(s)
   user profile information
   transaction history information
   recent user activities
   proximate business-related criteria (e.g., criteria which may be used to determine whether the client device is currently located at or near a recognized business establishment such as a bank, gas station, restaurant, supermarket, etc.)
Time Synchronization Engine (e.g., 504) which, for example, may be operable to manages universal time synchronization (e.g., via NTP and/or GPS)
Search Engine (e.g., 528) which, for example, may be operable to search for transactions, logs, items, accounts, options in the Be The House databases
Configuration Engine (e.g., 532) which, for example, may be operable to determine and handle configuration of various customized configuration parameters for one or more devices, component(s), system(s), process(es), etc.
Time Interpreter (e.g., 518) which, for example, may be operable to automatically and/or dynamically modify or change identifier activation and expiration time(s) based on various criteria such as, for example, time, location, transaction status, etc.
Authentication/Validation Component(s) (e.g., 547) (password, software/hardware info, SSL certificates) which, for example, may be operable to perform various types of authentication/validation tasks such as, for example, one or more of the following (or combinations thereof):
   verifying/authenticating devices,
   verifying passwords, passcodes, SSL certificates, biometric identification information, and/or other types of security-related information
   verify/validate activation and/or expiration times
In one implementation, the Authentication/Validation Component(s) may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning The user's biometric information (e.g., fingerprints, face, voice, eye/iris, etc.). In at least one implementation, various security features may be incorporated into the mobile client system to prevent unauthorized users from accessing confidential or sensitive information.
Transaction Processing Engine (e.g., 522) which, for example, may be operable to handle various types of transaction processing tasks such as, for example, one or more of the following (or combinations thereof):
   identifying/determining transaction type
   determining which payment gateway(s) to use
   associating databases information to identifiers
   etc.
OCR Processing Engine (e.g., 534) which, for example, may be operable to perform image processing and optical character recognition of images such as those captured by a mobile device camera, for example.
Database Manager (e.g., 526) which, for example, may be operable to handle various types of tasks relating to database updating, database management, database access, etc. In at least one embodiment, the Database Manager may be operable to manage TISS databases, Be The House Device Application databases, etc.
Log Component(s) (e.g., 510) which, for example, may be operable to generate and manage transactions history logs, system errors, connections from APIs, etc.
Status Tracking Component(s) (e.g., 512) which, for example, may be operable to automatically and/or dynamically determine, assign, and/or report updated transaction status information based, for example, on the state of the transaction. In at least one embodiment, the status of a given transaction may be reported as one or more of the following (or combinations thereof): Completed, Incomplete, Pending, Invalid, Error, Declined, Accepted, etc.
Gateway Component(s) (e.g., 514) which, for example, may be operable to facilitate and manage communications and transactions with external Payment Gateways.
Web Interface Component(s) (e.g., 508) which, for example, may be operable to facilitate and manage communications and transactions with Be The House web portal(s).
API Interface(s) to Application Server System(s) (e.g., 546) which, for example, may be operable to facilitate and manage communications and transactions with API Interface(s) to Application Server System(s)
API Interface(s) to 3rd Party Server System(s) (e.g., 548) which, for example, may be operable to facilitate and manage communications and transactions with API Interface(s) to 3rd Party Server System(s)
OCR Processing Engine (e.g., 534) which, for example, may be operable to perform image processing and optical character recognition of images such as those captured by a mobile device camera, for example.
At least one processor 510. In at least one embodiment, the processor(s) 510 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 516, which, for example, may include volatile memory (e.g., RAM), non-volatile memory (e.g., disk memory, FLASH memory, EPROMs, etc.), unalterable memory, and/or other types of memory. In at least one implementation, the memory 516 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein. Because such information and program instructions may be employed to implement at least a portion of the Be The House Gaming System techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 506 which, for example, may include wired interfaces and/or wireless interfaces. In at least one implementation, the interface(s) 506 may include functionality similar to at least a portion of functionality implemented by one or more computer system interfaces such as those described herein and/or generally known to one having ordinary skill in the art.
Device driver(s) 542. In at least one implementation, the device driver(s) 542 may include functionality similar to at least a portion of functionality implemented by one or more computer system driver devices such as those described herein and/or generally known to one having ordinary skill in the art.
One or more display(s) 535. According to various embodiments, such display(s) may be implemented using, for example, LCD display technology, OLED display technology, and/or other types of conventional display technology. In at least one implementation, display(s) 535 may be adapted to be flexible or bendable. Additionally, in at least one embodiment the information displayed on display(s) 535 may utilize e-ink technology (such as that available from E Ink Corporation, Cambridge, Mass., www.eink.com), or other suitable technology for reducing the power consumption of information displayed on the display(s) 535.
Email Server Component(s) 536, which, for example, may be configured or designed to provide various functions and operations relating to email activities and communications.
Web Server Component(s) 537, which, for example, may be configured or designed to provide various functions and operations relating to web server activities and communications.
Messaging Server Component(s) 538, which, for example, may be configured or designed to provide various functions and operations relating to text messaging and/or other social network messaging activities and/or communications.

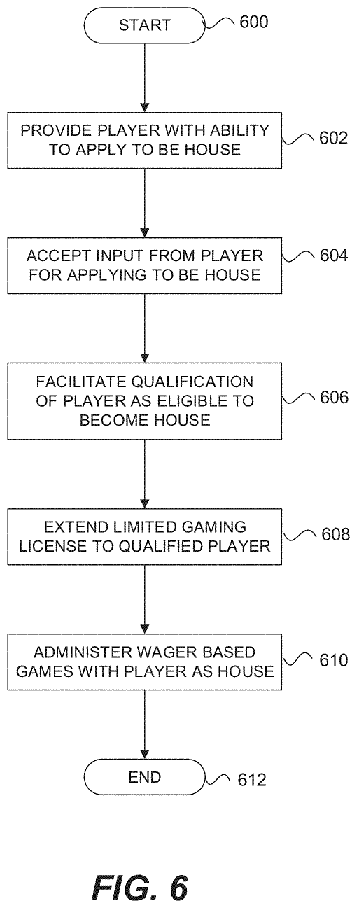

Referencing FIG. 6, a flowchart of one exemplary basic method of allowing a player to assume a house position is illustrated. After a start step 600, a suitable application or other mechanism to apply for a house type participant position is presented to a player or other user at a process step 602. Such an application can be, for example, part of an initial program on an application or “app” on a smart phone, or part of a browser application on a laptop or other personal computer device. This can be provided by way of a button or other opt in function, and may include a process of providing sufficient details regarding the applying player or user. Required information can include, for example, a name, address, identification number(s), banking information, and the like. Other details may also be required on the part of the hosting operator.

At a following process step 604, input is accepted from the player applying for a house type participant position. This can be by way of input provided through an app on a smart phone, through a browser application on a personal computer, in the form of a written application, over the phone or in person with a host operator representative, or any combination thereof, among other possible ways to provide player input. In various embodiments, sufficient information for an initial screening may be provided through a smart phone app or by other electronic format. This can be done by the player or user manually entering his or her personal information, for example.

At a subsequent process step 606, a qualification of the player or user as eligible to become a house type participant is facilitated. This can be done by way of providing or forwarding sufficient information regarding the player, such as from the player, or from one party to another on the host side, by evaluating at least a portion of that information on behalf of the host operator, by evaluating at least a portion of that information on behalf of a gaming regulatory body, determining whether the player or user applicant is financially solvent enough to become a house type participant, or any combination thereof, among other possible ways of facilitating the qualification of the player or user applicant.

If the player or user application is rejected, then no further processing beyond the rejection takes place. In the event that the player is indeed qualified to become a house type participant though, then a limited gaming license can be extended to the player at process step 608. Such a limited gaming license can be one that is provided and observed by a gaming regulatory body that regulates the gaming activities of the host operator. Such a limited gaming license can allow the now qualified player to conduct certain gaming activities as a house type participant, but does not allow the qualified player to conduct all gaming activities for which the host operator is licensed. In some embodiments, each such limited gaming license can be reviewed and granted on a case-by-case basis by the gaming regulatory body, and each limited gaming license can be specific or different from other limited gaming licenses. In some embodiments, the gaming regulatory body can provide authorization to grant limited licenses to the host operator at its discretion, such that the gaming regulatory body does not need to be concerned with such details of each separate individual limited gaming license. Such authorization may be limited only to certain features or aspects of a limited gaming license, and the gaming regulatory may elect to hold the host operator liable for any problems arising from such limited gaming licenses granted by the host operator without specific regulatory body oversight and approval.

At the following process step 610, wager based games are administered with the qualified player acting as house type participant. This can be done with the host operator administering the games and the qualified player acting as the house or bank position for all such games against regular players. Such games can be conducted over a network, such as the Internet or a closed proprietary network, for example. The qualified player acting as a house type participant can be in the same or a different gaming jurisdiction that the host operator and each of the regular players, who each may also be in the same or different gaming jurisdictions with respect to each other. The host operator administers the wager based games in terms of dealing cards or gaming items, determining wins and losses, and then providing the proper transfer of funds or credits as a result. The method then ends at end step 612.

For the foregoing flowchart, it will be readily appreciated that not every method step provided is always necessary, and that further steps not set forth herein may also be included. For example, added steps can involve providing software or information, allowing a user to change settings, and/or authenticating the user through a separate medium, such as a phone call, among other possible steps. Furthermore, the exact order of steps may be altered as desired, and some steps may be performed simultaneously. For example, steps 606 and 608 can be considered as being performed simultaneously in various embodiments. Not all steps are always necessary either. For example, step 608 may not be performed in all embodiments. Also, while the provided examples are with respect to computerized wager based games, it will be readily appreciated that the provided methods can also be used with respect to physical wager based games, as well as other alternative embodiments.

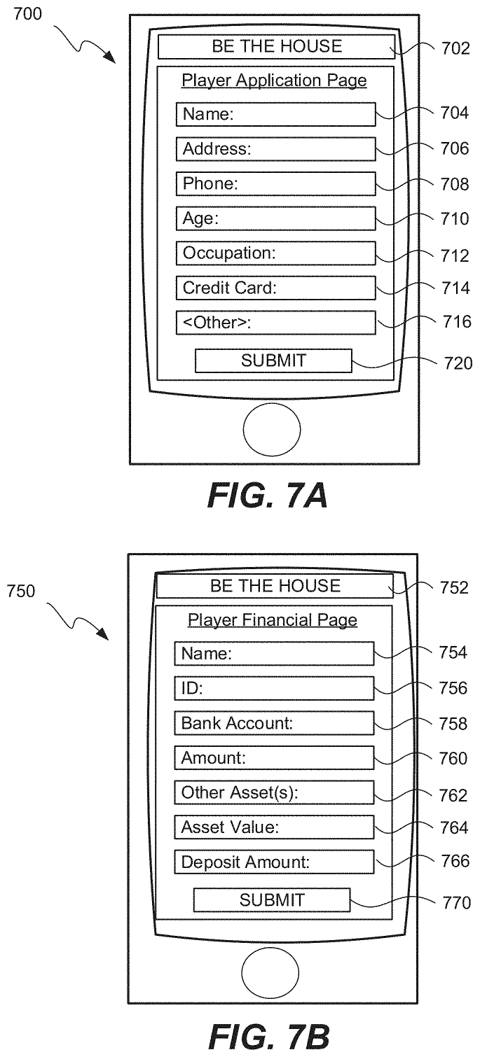

Transitioning now to FIGS. 7A and 7B, various arrangements for presenting a player application process for a Be The House Gaming System will now be provided and explained. Again, while such a gaming system can be used on a computer, smart phone, or other electronic device, physical in person and other playing arrangements are also contemplated. FIG. 7A illustrates an introductory screen shot of a Player Application Page for a player applying to become a house type participant, while FIG. 7B illustrates a screen shot of a Player Financial Page for an applying player. As shown in FIG. 7A, a screen shot 700 of an initial application process for a player can include a title banner 702, various fields 704-716 for entering personal information for the player, as well as a “submit” button 720 for finishing the entry of information and applying to be a house type participant, among other possible items. Informational fields can include, for example, name 704, address 706, phone 708, age 710, occupation 712, credit card 714, and other information 716 that may be needed by a host operator and/or gaming regulatory body in order to qualify an applicant for status as a house type participant. In some arrangements, sufficient information to enable a background check on the applicant may be desired. Although a single exemplary page is shown in FIG. 7A, it will be readily appreciated that multiple application pages and fields may be used for a player application.

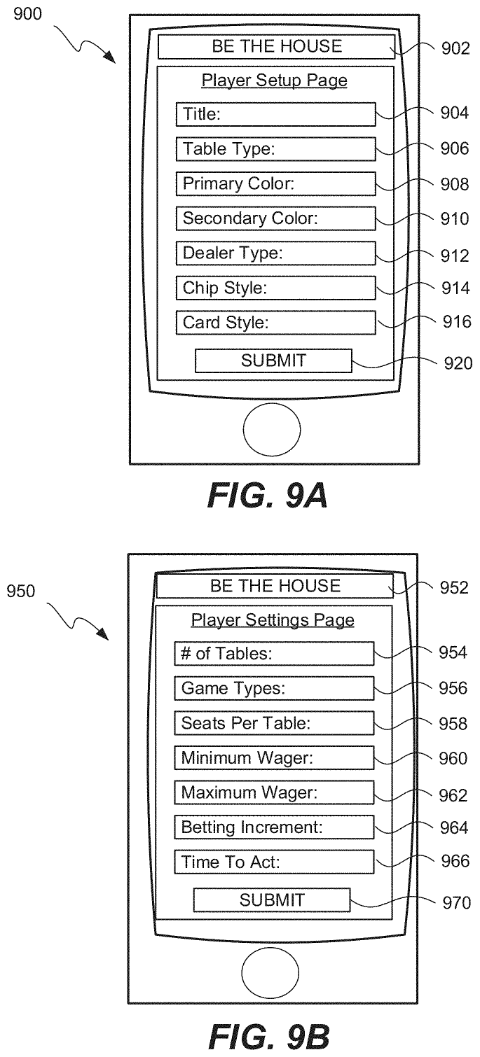

As shown in FIG. 7B, a screen shot 750 of a player financial page for a player applying to become a house type participant can include a title banner 752, various fields 754-766 for entering financial information for the player, and a “submit” button 770 for finishing the entry of information for an applying player, among other possible page items. Informational fields can include, for example, name 754, identification (“ID”) number or information 756, bank account information 758, bank account amount 760, other asset(s) 762, other asset value 764, and a deposit amount 766 that a player can make in order to be a house type participant. Other items may also be present as may be needed by a host operator and/or gaming regulatory body in order to qualify the financial information and deposit amount for an applicant to become a house type participant. Title banner 752 may be a “persistent” banner, in that it is the same as the banner 702 in the previous example, and may persist through other page views as well on the application. Again, while a single exemplary page is shown in FIG. 9B, it will be understood that multiple pages and fields may be used for entering applicant financial information, as may be needed.

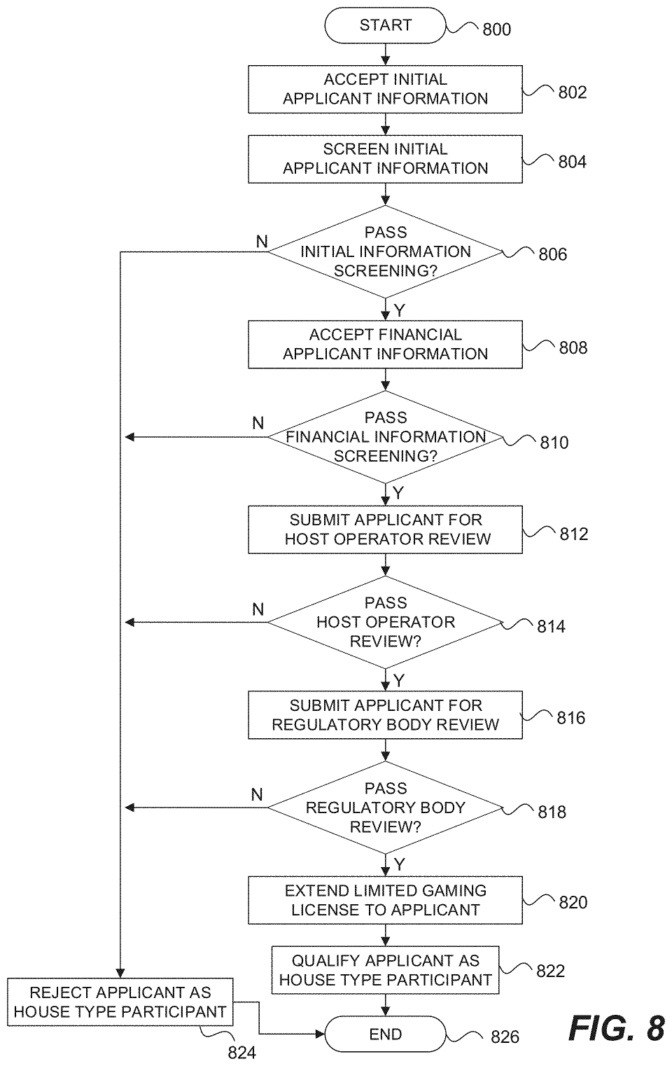

Continuing with FIG. 8, a flowchart of an exemplary method of qualifying a player to become a house type participant is illustrated. After a start step 800, initial application information for a player or user applying for a house type participant position (i.e., “applicant”) can be accepted at process step 802. Such initial application information can include, for example, that which may be submitted for the various items 704-716 above, among other possible informational items. At a following process step 804, the accepted initial application information can be screened for suitability. This screening of initial application information can be done manually, as part of an automated screening process, or both. Such a screening process can be suitable to eliminate or weed out applicants that are clearly not potential candidates to become a house type participant.

At a subsequent decision step 806, an inquiry can be made as to whether an applicant passes or is rejected by the screening of initial application information. Such screening rejections may be easy to make based on, for example, an improper age (too young) or a clear conflict of interest, such as with respect to occupation. If the initial screening returns a favorable result, then the method continues to the next process step 808. If the initial screening returns an unfavorable result, however, then the method moves to process step 824 where the applicant is rejected.

At process step 808, financial information for the player or user applying for a house type participant position is accepted. Such financial information can include, for example, that which may be submitted for the various items 754-766 above, among other possible financial informational items. At a following process step 810, the accepted financial information can also be screened for suitability. Again, such a screening of the financial information can be done manually, as part of an automated screening process, or both. Similar to the foregoing screening, a screening process with respect to the submitted financial information can eliminate or weed out applicants that are clearly not suitable candidates to become a house type participant based on financial ability.

At a subsequent decision step 810, an inquiry can be made as to whether an applicant passes or is rejected by the screening of financial information. Such screening rejections may be easy to make based on, for example, a bad credit history, insufficient credit, or an inability or unwillingness to deposit a sufficient amount of funds needed to be a house type participant. If the initial screening returns a favorable result, then the method continues to the next process step 812. If the initial screening returns an unfavorable result, however, then the method moves to process step 824 where the applicant is rejected.

At a following process step 812, an applicant that has passed the first two screenings can then be submitted for a thorough review by the host operator. Such a thorough review can be further automated, may be conducted by one or more host operator personnel, or by some combination of both. The thorough review can involve a more in depth weighing and considering of the submitted initial application information and financial information items, along with other details, if desired. Such a thorough review may involve requesting additional information from the applicant, such as through electronic communications or by phone call.

At a subsequent decision step 814, an inquiry can be made as to whether an applicant passes or is rejected by the thorough review of the host operator. Such decisions can be based on more detailed and varied factors, as will be readily appreciated. If the thorough review by the host returns a favorable result, then the method continues to the next process step 816. If the thorough review returns an unfavorable result, however, then the method moves to process step 824 where the applicant is rejected.

At a following optional process step 816, an application that has passed a thorough review by the host operator can be submitted for review by a gaming regulatory body. A gaming regulatory body review may be desirable where a particular gaming regulatory body that is granting limited gaming licenses for a Be The House Gaming System requires some amount of oversight with respect to some or all player applicants under the system. A decision on a given application by a governing gaming regulatory body can be based on the submitted information, additional information, and one or more detailed and varied factors that may not always be the same as the information, details, and factors weighed and considered by the host operator, as will be readily appreciated.

At a subsequent decision step 818, an inquiry can be made as to whether an applicant passes or is rejected by the gaming regulatory body. If the gaming regulatory body review returns a favorable result, then the method continues to the next process step 820. If the gaming regulatory body review returns an unfavorable result, however, then the method moves to process step 824 where the applicant is rejected.

At a following process step 820, a limited gaming license can be extended to the applicant (i.e., initially applying player or user), which limited gaming license can be extended directly from the gaming regulatory body, from the gaming regulatory body through the host operator, or from the host operator under the authority of the gaming regulatory body. At the next process step 822, the applicant is approved and is thereby qualified as a house type participant. After the applicant is qualified as a house type participant at step 822 or rejected at step 824, the method then ends at end step 826.

For the foregoing flowchart, it will be readily appreciated that not every method step provided is always necessary, and that further steps not set forth herein may also be included. For example, added steps can involve conducting background checks on an applicant, and/or utilizing a third party vetting service, among other possible steps. Furthermore, the exact order of steps may be altered as desired, and some steps may be performed simultaneously. For example, steps 820 and 822 can be considered as being performed simultaneously in various embodiments. Not all steps are always necessary either. For example, steps 816 and 818 may not be performed in all embodiments. Also, while the provided examples are with respect to computerized wager based games, it will be readily appreciated that the provided methods can also be used with respect to physical wager based games, as well as other alternative embodiments.

Additional details may also apply with respect to the various method steps for qualifying a player or other applicant. In some embodiments, a minimum deposit amount may vary from one host operator to another, and may even vary for different applicants to the same host operator. For example, a default minimum deposit amount for one host operator may be $10,000, while another host operator may require $100,000 as a minimum deposit amount. As another example, the same host operator may require a minimum deposit amount of $50,000 for an unknown applicant, while only requiring a minimum deposit amount of $5,000 for a well-known solvent corporate entity applicant. As yet another example, a gaming regulatory body may require a minimum deposit amount of $20,000 for all applicants regardless of any separate requirements of a host operator. In some arrangements, a minimum deposit might be made to a specific financial account dedicated to the player and controlled by the host operator. Alternatively, or in combination, a minimum deposit might be made to a separate escrow account controlled and managed by third party escrow provider. In such escrow arrangements, a separate financial account dedicated to the player and controlled by the host operator may also be used for regular operations, with the escrow account deposit functioning as a guarantee of eventual payment or reimbursement by the qualified player if necessary.

Further details regarding qualifying a player or other applicant (e.g., an individual, group of individuals, corporate entity, etc.) can involve a background check. For example, where the applicant is an individual, a background check might involve determining if the applicant has any criminal record or any past personal bankruptcies. Checking for other types of undesirable details can also be undertaken whether the applicant is an individual, group, or corporation. Again, such a background check or other applicant qualifying function may be required by a host operator, by a relevant gaming regulatory body, or both.

Once an applicant has been qualified as a house type participant, an appropriate deposit can be made into a dedicated player account, and the qualified player can begin to set up its customized table or section of an overall casino. FIGS. 9A and 9B provide various arrangements for a graphical user interface (GUI) on a Be The House Gaming System to allow a qualified player to set up his or her customized gaming table or section on the system. Again, while such a gaming system can be used on a computer, smart phone, or other electronic device, physical in person and other playing arrangements are also contemplated.

FIG. 9A illustrates a screen shot of an initial Player Setup Page for a qualified player that is initially setting up their presence as a house type participant, while FIG. 9B illustrates a screen shot of a Player Settings Page for a qualified and established house type participant to change the settings on his or her established presence. As shown in FIG. 9A, a screen shot 900 of an initial player setup for a qualified player can include a title banner 902, various fields 904-916 for entering setup selections for the qualified player, as well as a “submit” button 920 for finishing the setup process. Setup selection fields can include, for example, casino title 904, table type(s) 906, primary color scheme 908, secondary color scheme 910, dealer type(s) 912, chip style 914, card style 916, and various other setup selections that may be appropriate for creating the appearance of a casino in the name of the qualified player.

As in the foregoing examples, title banner 902 can be a persistent banner, or can change depending upon circumstances and host operator settings. Although a single exemplary page is shown in FIG. 9A, it will be readily appreciated that multiple setup pages and fields may be used for a player setup, as may be desired. For example, one set of player setup pages may involve the number of tables and types of games, while another set of player setup pages may relate to betting limits and increments, while still another set of player setup pages may be concerned with a customized presentation for the tables and games of the qualified player.

In various embodiments, a qualified player acting as a house type participant may be allowed to operate one or more gaming tables or machines in their own section under their own customized “skin” or presentation style. For example, while the theme for host operator sections or tables may be a flowery green and orange type of presentation for the tables and games, the theme for a qualified player acting as a house may be a silver and black sports type of theme. Various presentation items that may be customized for a qualified player operating their own gaming tables or section can include, for example, the felt on the tables, chip designs, dealer uniforms, scenery backgrounds, banner ads, table signage, drink and food presentation, and the like. Such customizations can allow a player to create their own mini casino, either virtually or in a particular area of a physical casino or other gaming establishment. Customizations such as these can be selected at an initial Player Setup Page or series of pages, such as that which is shown in FIG. 9A.

As shown in FIG. 9B, a screen shot 950 of a Player Settings Page for a player to change the settings can include a title banner 952, various fields 954-966 for entering or adjusting settings for the gaming tables or section of the qualified player, and a “submit” button 970 for finishing the entry or changing of settings, among other possible page items. Again, title banner 952 can be a persistent banner. Settings fields can include, for example, number of tables 954, game type(s) 956, number of seats per table 958, minimum wager amount(s) 960, maximum wager amount(s) 962, betting increments 964, time limit for a regular player to act 966, and various other settings that may be appropriate. As in the foregoing examples, while a single exemplary settings page is shown in FIG. 9B, it will be understood that multiple pages and fields may be used for entering settings with respect to the details of running games where the qualified player acts as a host type player.

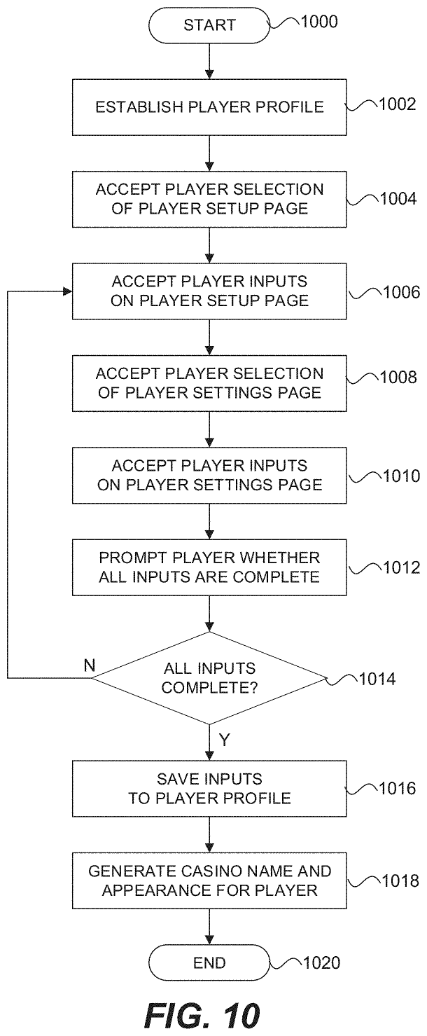

Continuing with FIG. 10, a flowchart of an exemplary method of a qualified player setting up a gaming table or section within the host operator establishment is illustrated. Again, while the examples provided relate primarily to a virtual or online casino or presence, it is also contemplated that the present disclosure may be applied to a physical casino or gaming establishment as well. After a start step 1000, a player profile can be established at process step 1002. After that, accepting a player selection of a player setup page can take place at process step 1004. At a following process step 1006, player inputs into the various fields on the player setup page can be accepted.

At a subsequent process step 1008, a player selection of a player settings page can table can be accepted. Player inputs into the various fields on the player settings page can then be accepted at process step 1010. After player inputs are made, a prompt can be provided to the player as to whether all inputs are complete at process step 1012. An inquiry can then be made at a decision step 1014 as to whether the player has indicated that all inputs are complete. This can involve a desire to add further inputs, or to change existing inputs that have already been entered.

If the inquiry is negative at decision step 1014, then the method can revert to process step 1006 for acceptance of more player inputs. Again, this can also involve a change in existing inputs. If the player has indicated that all inputs are complete at step 1012, however, then the method continues to process step 1016, where the inputs are all saved to the established player profile. A casino or section name and appearance (i.e., “skin”) on behalf of the player is then generated at process step 1018 based on all of the player selections and inputs. This can include the various colors, styles, designs, table appearances and seats, dealer uniforms, chips, cards, other presentations, and the like. The method then ends at end step 1020.

For the foregoing flowchart, it will be readily appreciated that not every method step provided is always necessary, and that further steps not set forth herein may also be included. Also, while the provided examples are with respect to computerized wager based games, it will again be readily appreciated that the provided methods can also be used with respect to physical wager based games.

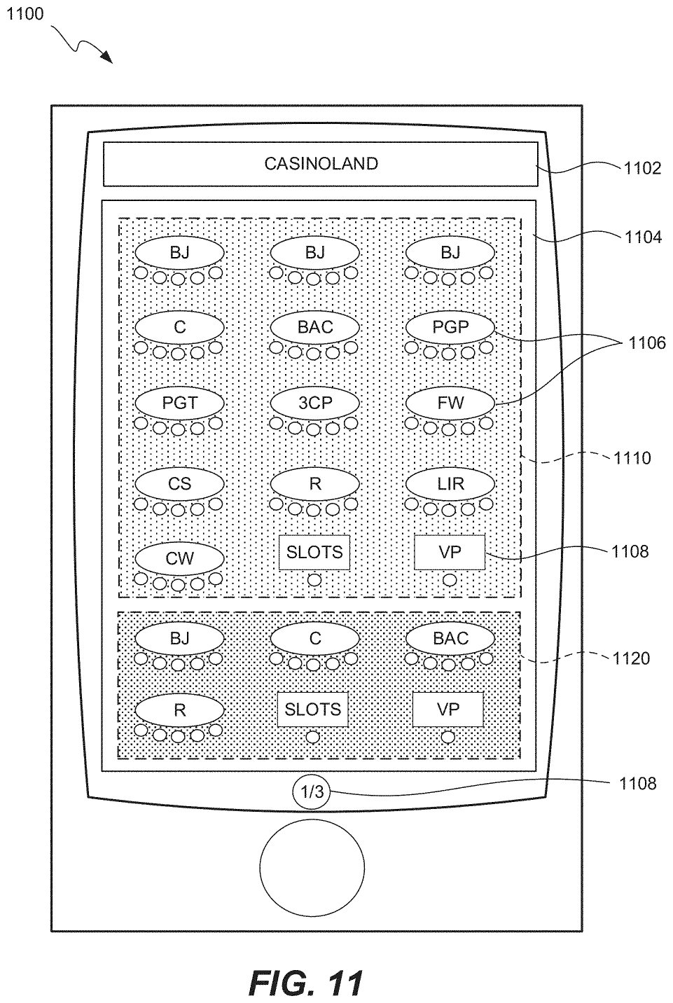

Moving next to FIG. 11, an exemplary screen shot of a virtual casino floor having a section for a qualified and established house type participant is illustrated. Screen shot 1100 depicts one page of an overall virtual casino that is administered by a host operator. Title banner 1102 can display the name of the overall virtual casino, which can be named “Casinoland,” for example. Of course, other casino names are also possible, which names can be original or can follow the branding of the host operator. Casino floor 1104 can include various gaming tables 1106 and other games where other players acting as regular player type participants can choose to have a seat and play table games. Gaming tables 1104 can include various casino type games such as, for example, blackjack (BJ), craps (C), baccarat (BAC), pai gow poker (PGP), pai gow tiles (PGT), 3-card poker (3CP), fortune wheel (FW), Caribbean Stud (CS), roulette (R), Let It Ride (LIR), and casino war (CW), among other possible games. In addition, stations or seats for regular slots and video poker (VP) may also be available on casino floor 1104.

Gaming tables 1106 on casino floor 1104 can be in a region or section 1110 that belongs to the host operator, as well as a section 1120 that belongs to a qualified player acting as a house type participant for those tables. Although only a single section 1120 belonging to a single qualified player is shown, it will be understood that a casino floor may have multiple sections belonging to different qualified players as well. While the color scheme, theme, décor, presentation style, and the like may be of one variety for the host operator section 1110 of casino floor 1104, the color scheme, theme, décor, presentation style, and the like for the qualified player section 1120 may all be different, as customized by the qualified player operating that section. A page indicator 1108 on the display can also be available to indicate which page of the overall casino floor is being viewed, such as where multiple pages of the overall casino floor may exist. As shown, page 1 of 3 for the floor of “Casinoland” is depicted in screen shot 1100. Further pages offering more gaming tables and potentially different games and gaming floor sections may also be available for a user scrolling through the offerings of Casinoland.

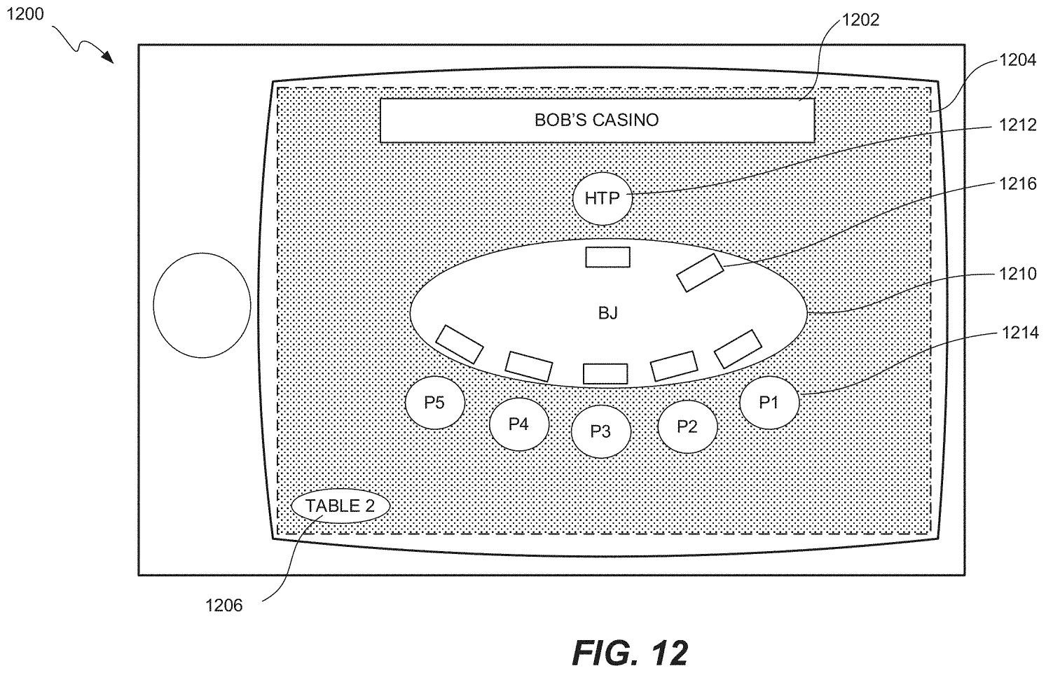

In various embodiments, a regular player visiting Casinoland and acting as a player type participant can select one of the gaming tables or other games displayed on the casino floor display, such as that which is shown in FIG. 11. Upon such a selection, the display can change to that of the selected table or game. FIG. 12 illustrates a screen shot of an exemplary virtual gaming table for a qualified and established house type participant from the perspective of another player acting as a player type participant. Screen shot 1200 can include a title banner 1202 that reflects the designated name or other title of the owner of the selected gaming table or game. As shown, the selected gaming table is part of a section belonging to a qualified player named “Bob.” Of course, other names and other titles may also be used for title banner 1202. The name of the person does not need to be used, and the owner of the table or section can elect to call their tables or section something else, such as a different name or title. In some embodiments, a table or section owner may decide to use title banner 1202 and other décor and presentation for advertising or branding purposes, which may be subject to approval of the host operator.

As shown, the selected gaming table may be part of a customized presentation or “skin” 1204 as selected by the gaming table operator. A table indicator 1206 may be included in the display to let the user know which table has been selected of the various tables that were available on the main display of casino floor 1104 above. The display can include a virtual gaming table 1210, which may be configured to play blackjack, for example. A dealer position or seat 1212 can designate the house type participant 1212, and multiple player positions 1214 can designate seats for ordinary player type participants, such as seats P1-P5, each seat having various play areas and other indicators dedicated thereto. A virtual card shoe and various other virtual devices, such as cards, chips, tokens and the like (not shown) can also be present at virtual gaming table 1210 in order to facilitate a festive and realistic play of table games.

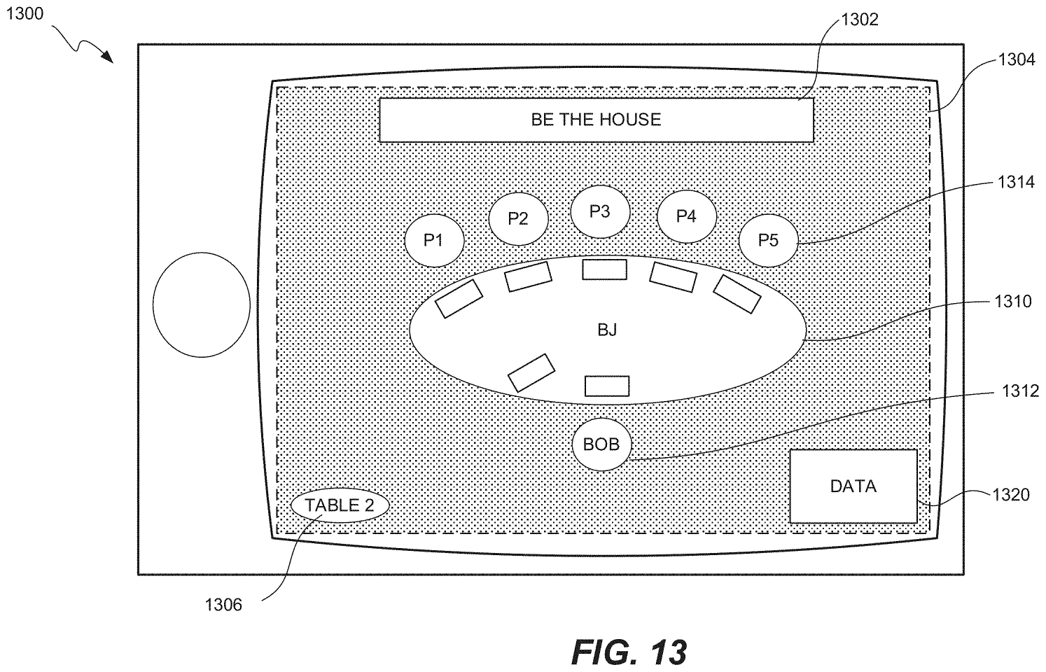

Continuing with FIG. 13, a screen shot of the exemplary virtual gaming table of FIG. 12 from the perspective of the established house type participant is shown. Screen shot 1300 can be similar to screen shot 1200 above, with several differences being shown to the qualified player acting as house type participant. Title banner 1302 can reflect something different for the house type participant. While a “Be The House” title may be displayed to the qualified player as house type participant by default, the qualified player may choose to change the title banner 1302 to something different for their own reference. A table indicator 1306 may also similarly note which table is being displayed out of multiple possible tables. A customized presentation 1304 may be the same or substantially similar to that of the customized presentation 1204 above, along with the display of gaming table 1310, dealer seat 1312, and multiple player seats P1-P5 1314.

While viewing game play at virtual gaming table 1310 from the perspective of the qualified player is possible, it will be readily appreciated that viewing such game play may not always be required. That is, the qualified player need not be present or viewing actively or passively any games being conducted at any of his or her tables in order for the games to take place and be administered by the host operator. In some situations, the qualified player acting as house type participant may desire to watch one or more games in real time, while in other situations the games can be played by live ordinary players and administered by the host operator without any live presence or oversight by the qualified player acting as house type participant. Of course, administration of any virtual games can be done on an automated basis, such as by systems and software run by the host operator.

In various embodiments, the qualified player may watch live games at any or all of his or her tables or gaming seats. In some cases, the play of various live games can be recorded for later viewing or review by the qualified player. In the event that the qualified player wishes to check in or note ongoing progress at any of his or her gaming tables, a data window 1320 can provide information regarding the play of games at that table. Such a data window 1320 can include a variety of informational items, and may be interactive such that the qualified player can check different statistics and review information about games being played and that have been played at that table. This can include both overall and recent information. In various arrangements, data window 1320 may have different settings to account for the preferences of what the qualified player may want to review at a glance. While data window 1320 may provide a snapshot or summary of information regarding the play of games at gaming table 1310, other provisions can be made for giving the qualified player information about the various games played. Such other provisions can include a more detailed data page, for example.

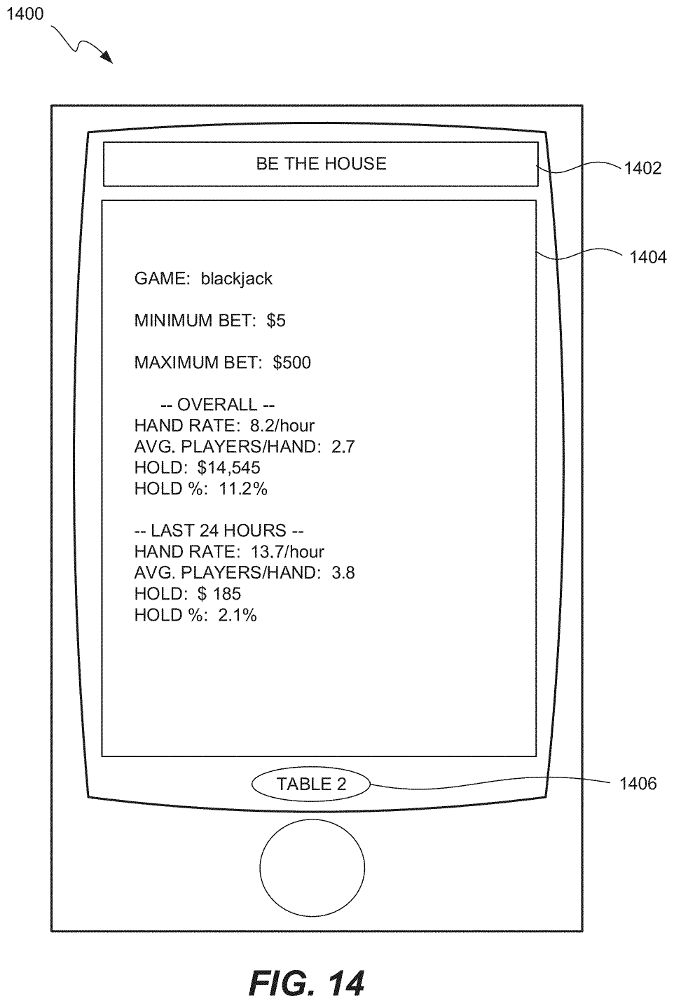

Moving next to FIG. 14, a screen shot of an exemplary data page for an active gaming table from the perspective of an established house type participant is shown. Screen shot 1400 can include various informational items and data regarding games played at one or more gaming tables. This information and data can include current, recent, and historical data, and may include more information than that which may be presented in a smaller data window 1320 above. As shown, the screen shot 1400 can include a title banner 1402, which again may have default and/or customizable settings, the actual data page 1404, which may have various informational items and data regarding games played, and a table indicator 1406 which shows which table is having its information and data displayed. Various informational items can be shown, such as, for example, the type of game, the minimum and maximum bets or wagers, the overall hand rate, the average number of players per hand, the hold being returned to the qualified player, and the hold percentage as a function of wagers made. The various rates, averages, holds, and percentages can be shown for the overall history of the given table, as well as for recent play periods, such as for the last 24 hours. Data for other recent play periods may also be provided, such as over the last hour, week, month, or year, among other possible time periods. Other information and data may also be provided, and it will be understood that the present example is shown only for purposes of illustration.

It will also be appreciated that a subset or summary of the data shown on data page 1404 can be shown in the data window 1320 above, such as information that the qualified player may desire to see at a simple glance when checking through his or her tables. Such a data summary may simply include the overall hold and hold percentage for the past 24 hours in some arrangements. Other information and data may also be provided to the player in similar data pages, such as the combined hold and hold percentages for all tables run by the qualified player, as well as the fees or percentages being deducted for the host operator and the net profit that is being realized by the qualified player. Further data page items can include payment statements and the status and balance of any player accounts, such as an escrow account or an account that is being held by the host operator. In various arrangements, the hosting operator may provide the banking players with profit and loss statements beyond the data provided in data windows or pages. This can be provided through any suitable profit and loss reporting statement procedures.

As will be appreciated from the foregoing details, a “Be The House” gaming system allows qualified players to assume a house position for the purpose of playing house-based games against other players, such that players are able to benefit from traditional house-only odds and advantages. This can require players to assume the risks of potentially large losses, and may also involve extend gaming license provisions from a governing body through the host operator to one or more qualified players. As an advantage to many that may become qualified players, such provisions can be made through the resources of an established gaming operator without requiring a traditional player to take on the prohibitive monetary and temporal costs of starting up their own casino or other gaming operation and continuing operations with resource intensive ongoing overhead and maintenance.

A licensed host casino or other gaming operator can also realize various advantages by attracting new customers and retaining existing ones by providing better offerings that allow customers to bank games as if they are the house. The hosting gaming operator can also eliminate their own risk of big losses in the event of players having big wins or winning streaks. The host operator can take a small fee or percentage based on the gaming actions when allowing players to assume a house position. This advantage can be significant in instances of high volume, particularly where the system is virtually based. Still further, the hosting gaming operator can benefit from increased advertising and promotional abilities by way of hosting such a gaming system.

In various embodiments, a qualified player may desire to remain anonymous. As such, the host operator can permit the qualified player to customize his or her table or section to be titled and branded in any way desired. This can involve an anonymous store front type of appearance or new branding, as may be desired. In some arrangements, the qualified player tables or sections may still be distinguishable from the host operator tables or sections, while in some arrangements the qualified player tables or sections can appear to be the same or be indistinguishable from the host operator tables or sections, at least from the perspective of ordinary players.

In addition, a qualified player running his or her own table or section of tables may be provided with various advertising opportunities. Qualified players may advertise themselves or on behalf of sponsors or other entities. For example, a player assuming a dealer position in a virtual casino may run a long standing popular enterprise where one or more advertisers may be employed to take advantage of that popularity. This can involve advertisements or mentions on the title banner, one or more side or bottom banners, and/or the overall décor and presentation of the qualified player section.

Qualified players may also be provided with bonuses or additional revenue, compensation, or credits to invite family, friends, or other persons to play at their virtual casinos, further increasing interest and overall play and participation. These various features may attract many players who might otherwise not play as much or at all. First time regular players may be provided with special incentives or player points or bonuses for initial play at the qualified player casino section. These special bonuses or incentives can be in addition to regular player points or credits that are typically awarded to all players that may be registered for play on the host operator system. Such initial special bonuses or incentives can be for a first play, first hour or day of play, first number of hands played, or any other suitable incentivized way to welcome new players.

In addition, a special set of qualified player points or credits may also be provided to the qualified player for attracting new players. In addition to regular player points or credits, qualified players may receive additional specialized qualified player points, which can be awarded at different rates and amounts for games played as a house type participant. Qualified player points can be awarded based on the number of games played, the time period for which the house type participant played in games, the number of games and tables played, and the amounts of money or credits risked, among other possible bases for awarding qualified player points. As noted above, additional qualified player points can be awarded for attracting new players, attracting sponsors, or facilitating other activities that are of benefit to the overall host operator and its system. The special set of qualified player points can be redeemed for rewards, “comps,” cash, or other consideration as preferred by the host operator providing the overall system.

In some arrangements, the specialized qualified player points can be used to unlock desirable features with respect to advertising or other bonuses that are not available to all qualified players. Such added features or bonuses can include customizations or additions with respect to advertising or the customized appearance or presentation of the player table or section of the casino. For example, a new qualified player may only have two or three types of customized presentation schemes or selections to choose from, with new selections or features being added as the qualified player accumulates specialized qualified player points. Again, such presentation items or décor for the player tables or section can include, for example, the felt on the tables, chip designs, dealer uniforms, scenery backgrounds, banner ads, and the like. Such customizations can allow a player to create their own mini casino, either virtually or in a particular area of a physical casino or other gaming establishment, with more options being available to qualified players having more qualified player points. Additional qualified player points rewards can include variations on the amount and types of games that the qualified player can act as a house type participant, the number of tables that the player can utilize, the number of player positions at a table, and/or reductions in the fee or compensation percentage charged to the player by the host operator.

In various embodiments, a qualified player can act as a house type participant for multiple traditional wagering games for a set time period, set number of hands or plays, or indefinitely, while the host operator administers, controls, and still profits somewhat from the games. The host operator can establish a minimum and/or maximum time period, number of hands or plays, set times of play, and minimum and/or maximum wager amounts that a qualified player must adhere to in running their own tables or section. For example, a host operator may require that a newly qualified player run a minimum of 1000 games at only one blackjack table, with a maximum of 5 seats, with betting limits from $5 to $50, from the hours of 10 AM to 10 PM only for exactly one month, whereupon the terms of use for the qualified player may be renewed or expanded. Other terms and conditions may be applied, and may vary from qualified player to qualified player. In some situations, each qualified player may have a separate contractual arrangement with the host operator. Every such contract may be different, or some contracts may be identical or similar, such as in the case of new and unknown individual qualified players.

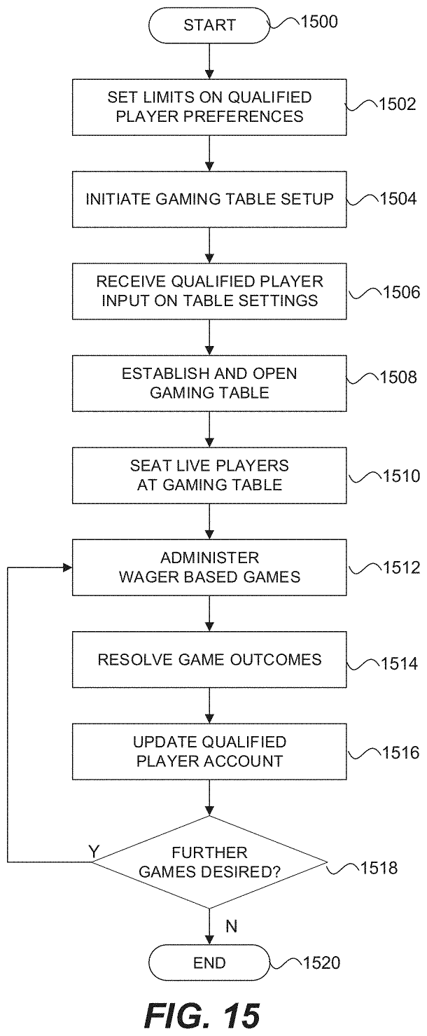

FIG. 15 illustrates a flowchart of an exemplary method of facilitating the play of a wager based game with a qualified player assuming a house position on a computing apparatus. After a start step 1500, a first process step 1502 can involve setting limits on what a qualified player is able to set up. This can involve, for example, limiting the types of games that the qualified player can run, limiting the amount of tables, the amount of seats per table, the minimum and maximum betting limits, and the time periods during which the qualified player can run games. A subsequent process step 1504 can include initiating a table setup on behalf of the player. Such a table setup can be according to the preferences of the qualified player within the limits set in the previous step.

At a following process step 1506, input can be received from the qualified player regarding the settings for a first gaming table. This input can include settings for the type of game, number of seats, and betting limits, among other input items. For example, a qualified player may enter that the table game should be blackjack, that there should be 5 player seats, that cards should be dealt from a 6 card shoe, that betting limits should range from $2 to $100, and that the game should run automatically 24 hours a day. At the next process step 1508, a gaming table with the player desired settings can be established and opened for play. This can involve creating and presenting a virtual table on the overall casino floor display, for example. This can also include presenting a representation of the qualified player or other dealer icon at the dealer position of the table.

At process step 1510, one or more regular live players can be seated at the established and open table. This can involve accepting selections of the table from one or more other live players and then seating such player(s) at the table for the play of games as player type participants in the games. At the next process step 1512, the play of wager based games can be administered. Such games can involve the placement of wagers by the player type participants and the conducting of game play against the house type participant based on the understood rules of the particular game being played. At a following process step 1514 the game outcomes can be resolved and appropriate payments taken or credits awarded depending on the wins and losses of the regular player type participants against the qualified player acting as a house type participant. At the next process step 1516, the qualified player account on the system can be updated according the resolution of the game outcomes and payments or credits.

At a subsequent decision step 1518, an inquiry can be made as to whether further games are desired. If any of the regular player type participants desires to continue the play of games, and if the qualified player desires to continue as the house type participant, then the method reverts to process step 1512 and steps 1512-1518 are repeated. If no further games are desired, however, then the method continues to and ends at end step 1520. This can result from no regular players wanting to continue the play of games, or from the qualified player wanting to stop or suspend his or her acting as a house type participant, at least for that subject table.

For the foregoing flowchart, it will be readily appreciated that not every method step provided is always necessary, and that further steps not set forth herein may also be included. For example, added steps can involve opening additional tables or gaming seats, and/or accepting player inputs, among other possible steps. Furthermore, the exact order of steps may be altered as desired, and some steps may be performed simultaneously. For example, steps 1508 and 1510 can be considered as being performed simultaneously in various embodiments. Again, while the provided examples are with respect to computerized wager based games, it will be readily appreciated that the provided methods can also be used with respect to physical wager based games, as well as other alternative embodiments.

Those skilled in the art will readily appreciate that any of the systems and methods of the disclosure may include various computer and network related software and hardware, such as programs, operating systems, memory storage devices, data input/output devices, data processors, servers with links to data communication systems, wireless or otherwise, and data transceiving terminals, and may be a standalone device or incorporated in another platform, such as an existing electronic gaming machine, portable computing device or electronic platforms with multiple player positions. In addition, the system of the disclosure may be provided at least in part on a personal computing device, such as home computer, laptop or mobile computing device through an online communication connection or connection with the Internet. Those skilled in the art will further appreciate that the precise types of software and hardware used are not vital to the full implementation of the methods of the disclosure so long as players and operators thereof are provided with useful access thereto or the opportunity to play the game as described herein.

The various aspects, embodiments, implementations or features of the described embodiments can be used separately or in any combination. Various aspects of the described embodiments can be implemented by software, hardware or a combination of hardware and software. Computer readable medium can be any data storage device that can store data which can thereafter be read by a computer system. Examples of computer readable medium include read-only memory, random-access memory, flash drives, USB drives, CD-ROMs, DVDs, magnetic disk drives, magnetic tape, optical data storage devices, and carrier waves. The computer readable medium can also be distributed over network-coupled computer systems so that the computer readable code is stored and executed in a distributed fashion.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

1. A wager based gaming system, comprising:
an interface configured for communications with at least one other device in the gaming system;
a memory; and
a controller coupled to the interface and the memory, wherein the controller is configured to execute a plurality of instructions stored in the memory for:
providing a player with the ability to apply for becoming a house type participant in the gaming system, wherein the gaming system is administered and controlled by a hosting operator licensed by a gaming regulatory body;
accepting input from the player regarding the player applying to become a house type participant in the gaming system, wherein the house type participant is allowed to assume a house position for multiple consecutive wager based games against other players in the gaming system;
facilitating the qualification of the player as eligible to become a house type participant in the gaming system, wherein said qualifying includes determining the ability of the player to assume a sufficient amount of risk with respect to being a house type participant;
extending a limited gaming license from the gaming regulatory body through the hosting operator to the qualified player, wherein the limited gaming license permits the qualified player to become a house type participant in at least one wager based type of game, but does not permit the qualified player to conduct all gaming activities that the hosting operator is licensed to conduct via its license from the gaming regulatory body; and
administering multiple wager based games on the gaming system with the qualified player acting as a house type participant and other players acting as player type participants.

2. (canceled)

3. The wager based gaming system of claim 1, wherein the controller is further configured to execute instructions stored in the memory for:
facilitating promotional activities regarding the qualified player to other players acting as player type participants.

4. The wager based gaming system of claim 3, wherein the promotional activities include advertising on behalf of the qualified player.

5. The wager based gaming system of claim 3, wherein the promotional activities include providing specialized house type participant player points to the qualified player.

6. The wager based gaming system of claim 3, wherein the promotional activities include providing player points and a specialized rate to other players acting as player type participants who play the multiple wager based games with the qualified player acting as the house type participant.

7. The wager based gaming system of claim 1, wherein the at least one wager based type of game is selected from the group consisting of blackjack, roulette, craps, Three Card Poker, Let It Ride, Caribbean Stud, Fortune Wheel, Casino War, slots, and video poker.

8. The wager based gaming system of claim 1, wherein the multiple wager based games are provided over the Internet.

9. The wager based gaming system of claim 1, wherein the multiple wager based games are played with the qualified player acting as a house type participant being located in a first gaming jurisdiction and at least one other player acting as player type participant being located in a second gaming jurisdiction separate from the first gaming jurisdiction.

10. The wager based gaming system of claim 1, wherein determining the ability of the player to assume a sufficient amount of risk with respect to being a house type participant includes requiring a minimum monetary deposit into a secure holding account.

11. The wager based gaming system of claim 1, wherein facilitating the qualification of the player as eligible to become a house type participant in the gaming system includes requiring the player to act as house type participant for a minimum number of wager based games, a minimum amount of time, or both.

12. A non-transitory computer readable medium including at least computer program code for presenting a wager based game using a computing apparatus, the computer readable medium comprising:
computer program code for providing to a user via a computing apparatus the ability to apply for becoming a house type participant in the gaming system, wherein the gaming system is administered and controlled by a hosting operator licensed by a gaming regulatory body;
computer program code for accepting input from the player regarding the player applying to become a house type participant in the gaming system, wherein the house type participant is allowed to assume a house position for multiple consecutive wager based games against other players in the gaming system;
computer program code for facilitating the qualification of the player as eligible to become a house type participant in the gaming system, wherein said qualifying includes determining the ability of the player to assume a sufficient amount of risk with respect to being a house type participant;
computer program code for facilitating the extension of a limited gaming license from the gaming regulatory body through the hosting operator to the qualified player, wherein the limited gaming license permits the qualified player to become a house type participant in at least one wager based type of game, but does not permit the qualified player to conduct all gaming activities that the hosting operator is licensed to conduct via its license from the gaming regulatory body; and
computer program code for facilitating the administration of multiple wager based games on the gaming system with the qualified player acting as a house type participant and other players acting as player type participants.

13. (canceled)

14. The non-transitory computer readable medium of claim 12, further comprising:
computer program code for facilitating promotional activities regarding the qualified player to other players acting as player type participants.

15. The non-transitory computer readable medium of claim 12, wherein the computer program code includes the ability to provide the multiple wager based games with the qualified player acting as a house type participant being located in a first gaming jurisdiction and at least one other player acting as player type participant being located in a second gaming jurisdiction separate from the first gaming jurisdiction.

16. The non-transitory computer readable medium of claim 12, wherein the computer program code for facilitating the qualification of the player includes code requiring a minimum monetary deposit into a secure holding account.

17. (canceled)

18. A method of facilitating a wager based game using a computing apparatus, the method comprising:
providing a player with the ability to apply for becoming a house type participant in the gaming system, wherein the gaming system is administered and controlled by a hosting operator licensed by a gaming regulatory body;
accepting input from the player regarding the player applying to become a house type participant in the gaming system, wherein the house type participant is allowed to assume a house position for multiple consecutive wager based games against other players in the gaming system;
facilitating the qualification of the player as eligible to become a house type participant in the gaming system, wherein said qualifying includes determining the ability of the player to assume a sufficient amount of risk with respect to being a house type participant;
extending a limited gaming license from the gaming regulatory body through the hosting operator to the qualified player, wherein the limited gaming license permits the qualified player to become a house type participant in at least one wager based type of game, but does not permit the qualified player to conduct all gaming activities that the hosting operator is licensed to conduct via its license from the gaming regulatory body; and
administering multiple wager based games on the gaming system with the qualified player acting as a house type participant and other players acting as player type participants.

19. (canceled)

20. The method of claim 18, further comprising:
facilitating promotional activities regarding the qualified player to other players acting as player type participants.

21. The wager based gaming system of claim 1, wherein the controller is further configured to execute instructions stored in the memory for:
allowing the qualified player to remain anonymous to the other players acting as player type participants.

22. The wager based gaming system of claim 1, wherein the wager based gaming system allows the hosting operator to eliminate its own risk of loss against the other players acting as player type participants.

23. The wager based gaming system of claim 1, wherein facilitating the qualification of the player as eligible to become a house type participant in the gaming system includes an initial screening process by the hosting operator, a subsequent thorough review by the hosting operator, and a review by the gaming regulatory body.

24. The wager based gaming system of claim 1, wherein the controller is further configured to execute instructions stored in the memory for:
allowing the qualified player to act as a house type participant in multiple wager based games at multiple gaming tables or gaming machines simultaneously.
